(19) United States
(12) Patent Application Publication
(10) Pub. No.: US 2025/0233786 A1
(43) Pub. Date: Jul. 17, 2025

(54) MULTIPLE FFT OPERATIONS FOR WIDEBAND OPERATIONS

(71) Applicant: QUALCOMM Incorporated, San Diego, CA (US)

(72) Inventors: Kangqi LIU, San Diego, CA (US); Peizhi WU, San Diego, CA (US); Jing SUN, San Diego, CA (US); Jing JIANG, San Diego, CA (US); Lei XIAO, San Jose, CA (US); Jae Ho RYU, San Diego, CA (US); Tingfang JI, San Diego, CA (US)

(21) Appl. No.: 18/414,359

(22) Filed: Jan. 16, 2024

(51) Int. Cl. H04L 27/26

(52) U.S. Cl. CPC H04L 27/2636; H04L 27/26414

(57) ABSTRACT

A method for wireless communication at a UE and related apparatus are provided. In the method, the UE obtains a first wideband signal having a continuous wideband bandwidth, and separates the first wideband signal into multiple narrowband segments. The multiple narrowband segments each have a narrowband bandwidth less than the continuous wideband bandwidth and different frequency shifts. The UE further performs multiple FFT operations on the multiple narrowband segments to obtain a set of processed segments respectively corresponding to the multiple narrowband segments, and aggregates the set of processed segments to obtain a second wideband signal.

### TECHNICAL FIELD

The present disclosure relates generally to communication systems, and more particularly, to multiple Fast Fourier Transform (FFT) operations for wideband operations in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to obtain a first wideband signal having a continuous wideband bandwidth; separate the first wideband signal into multiple narrowband segments, where the multiple narrowband segments each have a narrowband bandwidth less than the continuous wideband bandwidth and different frequency shifts; perform multiple Faster Fourier Transform (FFT) operations on the multiple narrowband segments to obtain a set of processed segments respectively corresponding to the multiple narrowband segments; and aggregate the set of processed segments to obtain a second wideband signal.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to receive, from a UE, a wideband capability indicator that indicates a capability for performing multiple FFT operations on multiple narrowband segments of a wideband signal; and communicate the wideband signal, where the wideband signal has a continuous wideband bandwidth, the multiple narrowband segments each have different frequency shifts, and the wideband signal is associated with the multiple FFT operations.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example frequency ranges (FRs) available for wireless communication.

FIG. 5 is a diagram illustrating an example of employing multiple FFT operations on a wideband signal in accordance with various aspects of the present disclosure.

FIG. 6 is a diagram illustrating an example of extracting narrowband signals from a continuous wideband signal without guard bands in accordance with various aspects of the present disclosure.

FIG. 7 is a diagram illustrating an example of employing multiple FFT operations on a wideband signal in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

Advancements in wireless communication technologies have seen a consistent increase in the bandwidth for communication. For example, the system bandwidths allocated for newer wireless communication technologies, such as 6G communications, may range from approximately 400 MHz to 1 GHz per operator. While this expansion enhances the network capabilities, it also presents unique challenges. For example, the conventional approach of using a single Fast Fourier transform (FFT) operation becomes insufficient to handle such wide bandwidths, especially when the subcarrier spacing (SCS) remains narrow (e.g., at 30 KHz) to manage the multi-path delay. Example aspects presented herein introduce methods and apparatus for using multiple FFT operations for wideband operations.

Various aspects relate generally to wireless communication. Some aspects more specifically relate to multiple FFT operations for wideband operations in wireless communication. In some examples, the UE obtains a first wideband signal having a continuous wideband bandwidth and separates the first wideband signal into multiple narrowband segments. Each of the multiple narrowband segments may have a narrowband bandwidth less than the continuous wideband bandwidth and may have different frequency shifts. The UE further performs multiple FFT operations on the multiple narrowband segments to obtain a set of processed segments corresponding to the multiple narrowband segments and aggregates the set of processed segments to obtain a second wideband signal. In some aspects, the UE may further transmit to a network entity a wideband capability indicator that indicates its capability for performing multiple FFT operations on the multiple narrowband segments to obtain the set of processed segments. The capability may include the maximum continuous wideband bandwidth, the maximum continuous narrowband bandwidth, or the maximum number of the FFT operations supported in downlink (DL) reception, uplink (UL) transmission, or a combination of the DL reception and the UL transmission. In some aspects, the wideband capability indicator may further include a phase alignment indicator that indicates whether the UE supports a phase alignment and concatenation operation after the multiple FFT operations.

Particular aspects of the subject matter described in this disclosure can be implemented to realize one or more of the following potential advantages. In some examples, by allowing the UE to divide a wideband signal into multiple narrowband segments and subsequently perform multiple FFT operations on these narrowband segments, as opposed to conducting a single FFT operation on the entire wideband signal, the described techniques allow for more efficient processing of wideband signals to accommodate a variety of use cases. In some examples, by incorporating a phase alignment and concatenation function to ensure phase continuity across the wideband bandwidth, the described techniques allow the removal of guard bands within the wideband bandwidth and therefore enhance the resource efficiency of wireless communication. In some examples, by enabling communication between the UE and the network regarding configurations or capabilities for the multiple FFT operations, such as supported bandwidths and phase alignment configurations, the described techniques can be customized to accommodate UEs with varying capabilities, thereby enhancing the overall functionality and efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

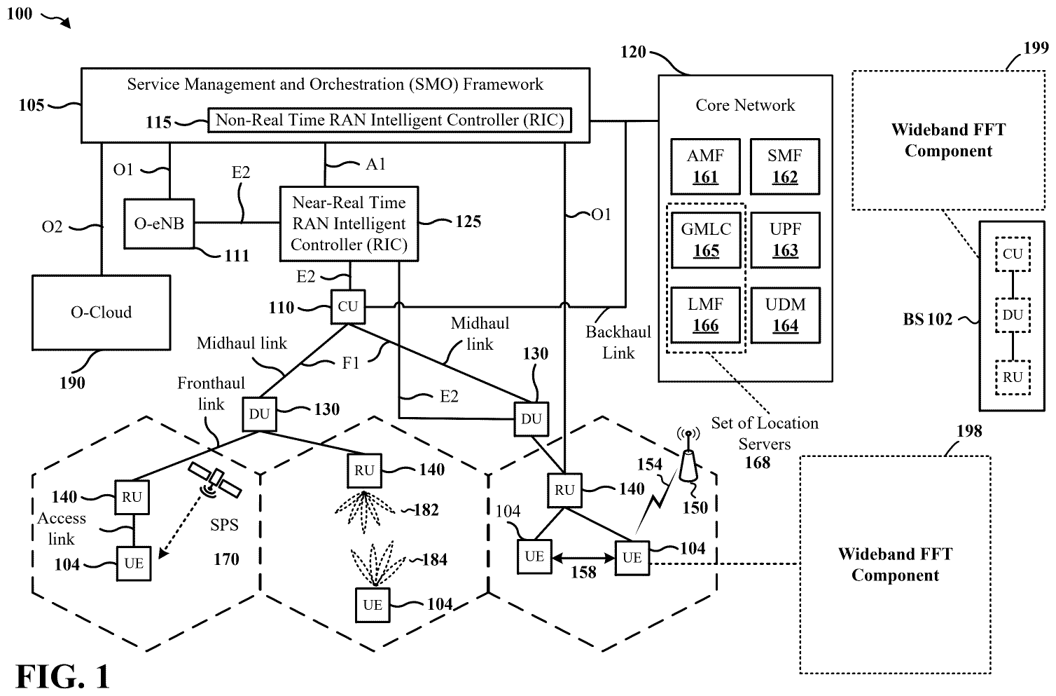

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a wideband FFT component 198. The wideband FFT component 198 may be configured to obtain a first wideband signal having a continuous wideband bandwidth; separate the first wideband signal into multiple narrowband segments, where the multiple narrowband segments each have a narrowband bandwidth less than the continuous wideband bandwidth and different frequency shifts; perform multiple FFT operations on the multiple narrowband segments to obtain a set of processed segments respectively corresponding to the multiple narrowband segments; and aggregate the set of processed segments to obtain a second wideband signal. In certain aspects, the base station 102 may include a wideband FFT component 199. The wideband FFT component 199 may be configured to receive, from a UE, a wideband capability indicator that indicates a capability for performing multiple FFT operations on multiple narrowband segments of a wideband signal; and communicate the wideband signal, where the wideband signal has a continuous wideband bandwidth, the multiple narrowband segments each have different frequency shifts, and the wideband signal is associated with the multiple FFT operations. Although the following description may be focused on 5G NR, the concepts described herein may be applicable to other similar areas, such as LTE, LTE-A, CDMA, GSM, and other wireless technologies.

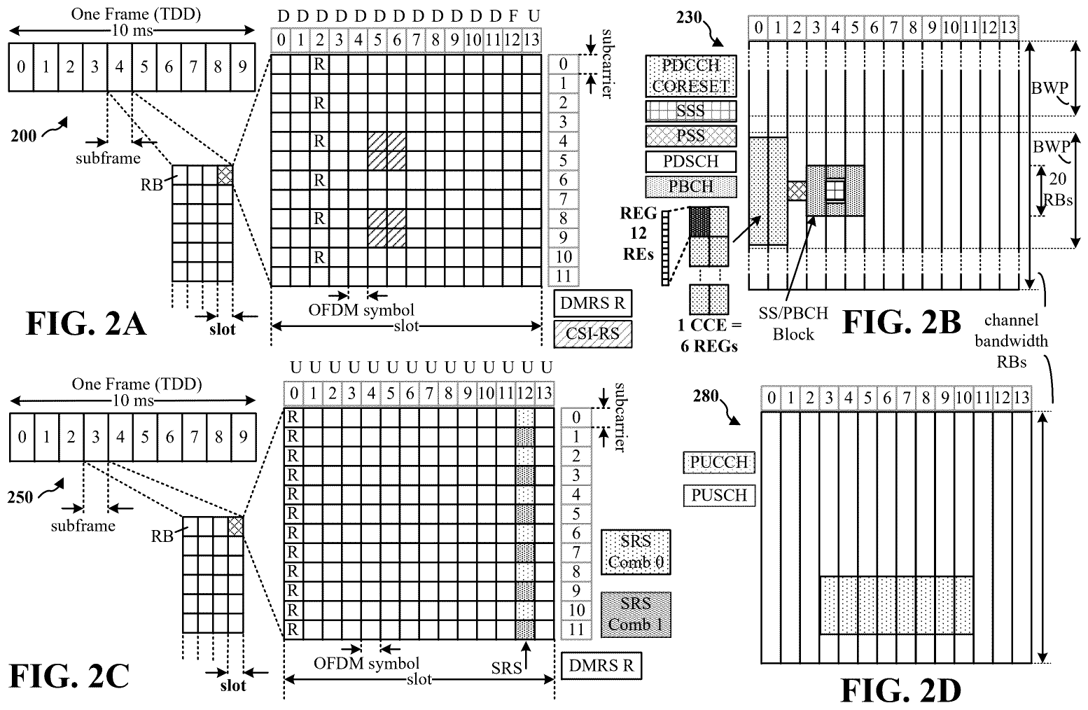

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2^{μ} allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

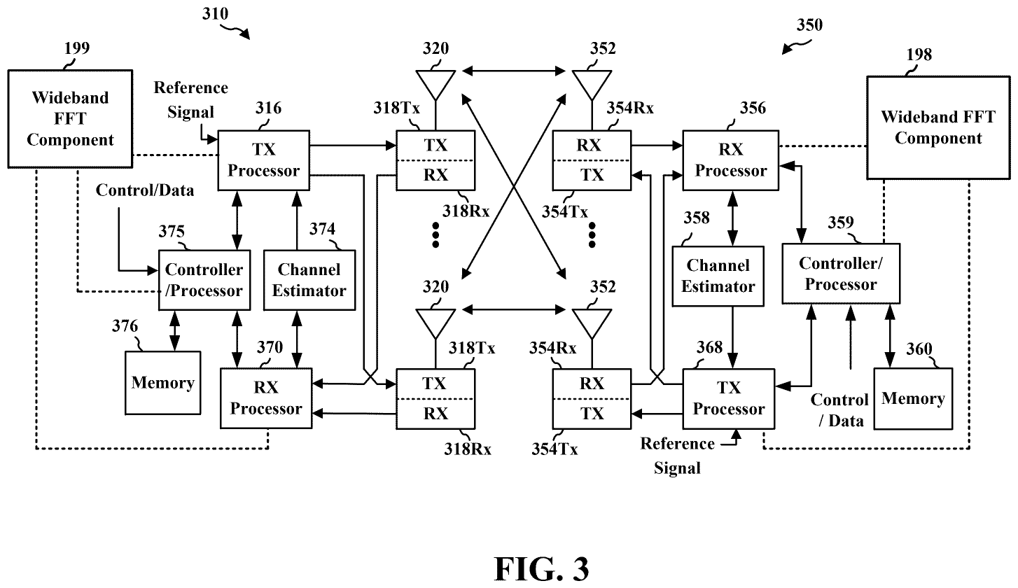

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the wideband FFT component 198 of FIG. 1.

At least one of the TX processor 316, the RX processor 370, and the controller/processor 375 may be configured to perform aspects in connection with the wideband FFT component 199 of FIG. 1.

Example aspects presented herein provide methods and apparatus for using multiple FFT operations (e.g., 4K-FFT) to implement an effective wideband FFT operation (e.g., 16K-FFT). These methods are applicable for low-tier UEs, which may not support phase alignment and compensation, and high-tier UEs, which support phase alignment and compensation.

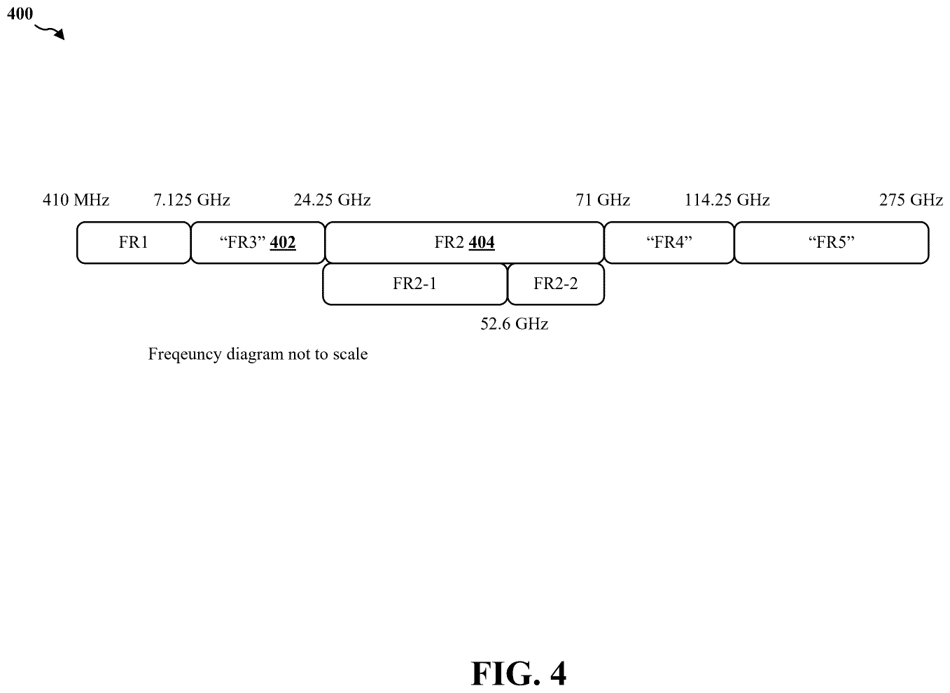

Wireless communication technologies have experienced significant spectrum growth across different generations (Gs), facilitated by spectrum aggregation and sharing strategies, for example. The spectrum growths have allowed for gains through larger carrier bandwidths in new bands for each generation. Table 2 shows example carrier bandwidths for different generations of wireless communication. FIG. 4 is a diagram 400 illustrating example frequency ranges (FRs) available for wireless communication.

TABLE 2
Example carrier bandwidths for difference
generations (Gs) of wireless communication.

| | Carrier | | |
|---|---|---|---|
| G | Bandwidth | | Notes |
| 2G | 200 kHz | | |
| | (GSM) | | |
| | 1.25 MHz | | |
| | (IS-95) | | |
| 3G | 5 | MHz | 4X with respect to the previous generation (G) |
| 4G | 20 | MHz | 4X with respect to the previous generation (G) |
| | | | Carrier Aggregation used to close gap with |
| | | | subsequent G |
| 5G | 100 | MHz | 5X with respect to the previous generation (G) |
| | | | Millimeter wave (mmW) that enables 200 MHz and |
| | | | 400 MHz component carriers |

| | | |
|---|---|---|
| 6G | 400 MHz- | Wireless applications have steadily demanded |
| | 500 MHz | increased availability of spectrum (~500 MHz-1 |

GHz per operator)

However, new spectrum with sufficient coverage may not be globally uniformly allocated. Finding large swathes of new spectrum for cellular use has become increasingly challenging, particularly as propagation conditions become harsher at higher frequencies. Despite these challenges, the large amount of spectrum allocated to FR2 404 for 5G makes the justification for identifying further International Mobile Telecommunications (IMT) spectrum difficult. For potential 6G spectrum for wide area coverage, the spectrum may include Frequency Range 3 (FR3) 402, which spans from approximately 7 GHz to approximately 24 GHz, with lower frequencies being more favorable due to better propagation characteristics. Additionally, the upper-6 GHz band may also be used in some regions. The wireless communication in 6G will likely be “spectrum sharing native,” meaning 6G communication may be deployed in bands already used for 5G.

In wireless communication, such as 6G, the allocation of system bandwidth may be in the range of approximately 400 MHz to 1 GHz per operator (i.e., telecommunications service provider or carrier). Meanwhile, the subcarrier spacing (SCS) might still be selected as 30 KHz to deal with the multi-path delay. Taking the scenario of 30 KHz SCS at a 400 MHz bandwidth, for example, this may result in about 13,000 tones in total. However, a single 4K Fast Fourier Transformation (FFT) operation (i.e., the FFT operation with the input signal size of 4096) may be unable to deal with these 13,000 tones in each symbol.

To address this issue, one potential scheme involves the use of a 16K FFT (i.e., the FFT operation with the input signal size of 16384) to extract the 13K tones in each symbol. However, implementing a large FFT size (e.g., a 16K FFT) in a modem may not be favorable due to, for example, the complex nature of the manufacturing processes involved. An alternative scheme may involve dividing the 400 MHz bandwidth into four separate 100 MHz component carriers (CCs) for multiple-CC operation. However, this method may necessitate the inclusion of guard bands between adjacent 100 MHz CCs, leading to less efficient resource utilization.

In light of these considerations, example aspects presented herein provide schemes that utilize multiple 4K-FFT operations for wideband operations, which may be regarded as a new capability for 6G UEs. The proposed schemes allow for the allocation of a continuous wideband (e.g., exceeding a bandwidth of 100 MHz or 4K tones) to UEs that support such a capability. This approach avoids the complications associated with integrating large FFT size handling capabilities into a modem. Additionally, it may eliminate the guard bands within the entire wideband bandwidth, resulting in more efficient utilization of resources.

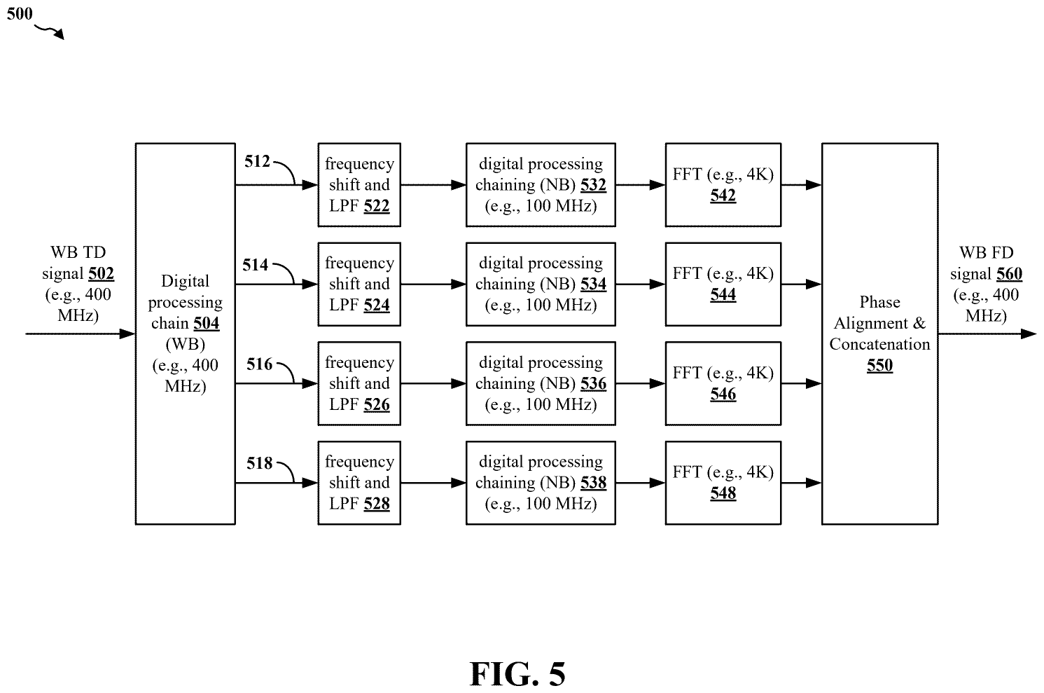

FIG. 5 is a diagram 500 illustrating an example of employing multiple FFT operations on a wideband signal in accordance with various aspects of the present disclosure. As shown in FIG. 5, in some aspects, the input wideband (WB) signal may be a WB time-domain (TD) signal 502, which may have a wideband bandwidth of 400 MHz, for example. The WB TD signal 502 may be processed through a WB digital processing chain 504, which may divide the WB TD signal 502 into multiple narrowband segments. In the example in FIG. 5, the WB TD signal 502 may be separated into four narrowband segments. Each of these narrowband segments may go through a separate FFT path (e.g., FFT paths 512, 514, 516, 518). Within each FFT path (e.g., 512, 514, 516, or 518), the relevant narrowband segment may be subject to a frequency shift and a low pass filter (e.g., 522, 524, 526, 528), followed by a narrowband (NB) digital processing chain (e.g., 532, 534, 536, 538), and then an FFT operation (e.g., 542, 544, 546, 548) to produce a processed segment. Each narrowband segment may go through a unique frequency shift. For example, if the WB TD signal 502 has a wideband bandwidth of 400 MHz, the frequency shifts at 522, 524, 526, and 528 may differ by 100 MHz each.

Following the FFT operations (e.g., 542, 544, 546, 548), the processed segments may be aggregated to form an output wideband signal (e.g., the WB frequency-domain (FD) signal 560). In the example where the input wideband signal (e.g., the WB TD signal 502) has a wideband bandwidth of 400 MHz, the bandwidth of the output wideband signal (e.g., the WB FD signal 560) may also be 400 MHz. In some examples, after the FFT operations (e.g., at 542, 544, 546, 548), the processed segments may undergo a phase alignment and concatenation function 550. The decision to implement the phase alignment and concatenation function 550 may vary based on the UE's capability. If performed, the phase alignment and concatenation function 550 may ensure that the phase is continuous across the entire bandwidth of the output wideband signal (e.g., the WB FD signal 560). However, if the phase alignment and concatenation function 550 is not performed, there may be phase glitches between the processed segments (e.g., among each 100 MHz bandwidth of the processed segments) that constitute the output wideband signal (e.g., the WB FD signal 560). FIG. 5 illustrates an example application of the multiple FFT operations on a wideband signal. The multiple FFT operations may be applicable to DL reception or UL transmission. During DL reception, the UE may receive the input wideband signal from the network, such as a base station. For UL transmission, the UE may utilize multiple FFT operations to prepare the output wideband signal and then send the wideband signal to the network, such as a base station.

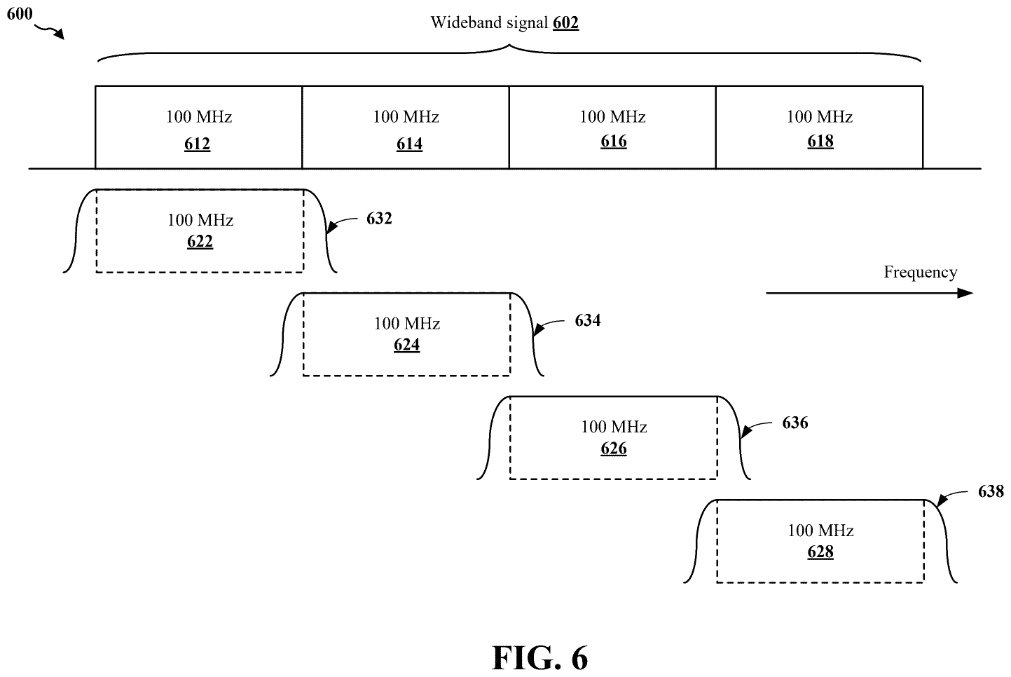

In some examples, the network (NW), such as a base station in a 6G network, may transmit or receive a continuous wideband bandwidth (e.g., 400 MHz) waveform with phase continuity by the NW implementation. In some aspects, the NW may indicate this transmission or reception to the UE based on the UE's capability. FIG. 6 is a diagram 600 illustrating an example of extracting narrowband signals from a continuous wideband signal without guard bands in accordance with various aspects of the present disclosure. In FIG. 6, the wideband signal 602 may have a continuous wideband bandwidth (e.g., without any guard bands within the wideband). As an example, the wideband bandwidth may be 400 MHz. The wideband signal 602 may be divided (e.g., by the digital processing chain 504) into four narrowband segments 612, 614, 616, and 618, each with a narrowband bandwidth of 100 MHz. Following the low pass filter (LPF), such as the LPF in 522, 524, 526, and 528, the frequency components of the four narrow bands (622, 624, 626, 628) may expand beyond their original 100 MHz frequency bandwidth, as shown by the curved contour 632, 634, 636, and 638, respectively. Hence, without the phase alignment and concatenation function (550), processing each narrowband segment (e.g., 100 MHz segments) separately may lead to phase glitches between the segments. However, if the phase alignment and concatenation function (550) is enabled, and assuming the wideband signal transmitted from the NW (e.g., WB TD signal 502) has phase continuity, the phase across the entire wideband (e.g., 400 MHz bandwidth) may remain continuous.

Some aspects of the present disclosure involve the UE's capability to report the multiple FFT operations for wideband operations. In some aspects, a UE may be indicated to report its capability to support multiple FFT operations for wideband operations. This capability may include several elements, such as the maximum continuous wideband bandwidth the UE supports in DL reception, UL transmission, or a combination of DL reception and UL transmission, the maximum continuous narrowband bandwidth the UE supports for each FFT in DL reception, UL transmission, and the combination of the DL reception and DL transmission, and the maximum number of FFT operations that can be used in DL wideband reception, UL wideband transmission, and the combination of DL wideband reception and UL wideband transmission.

In some aspects, this capability may further include whether the UE supports the phase alignment and concatenation function (e.g., 550). For low-tier UEs that may not support the phase alignment and concatenation function (e.g., 550), the network may expect the UEs to extract each narrowband segment without phase continuity. Nonetheless, the network may still transmit a continuous wideband bandwidth (e.g., 400 MHz bandwidth) waveform with phase continuity in 6G, implemented by the network. On the other hand, for high-tier UEs that support the phase alignment and concatenation function (e.g., 550), the network may indicate a phase continuity configuration to the UE via control signaling, such as radio resource control (RRC), a medium access control (MAC)-control element (MAC-CE), or downlink control information (DCI). In some examples, the phase continuity configuration may specify one or more of the DL phase continuity indicator or the UL phase continuity indicator. For example, the DL phase continuity indicator may specify whether the phase is continuous across different narrowband segments in DL transmission, and the UL phase continuity indicator may specify whether the phase should be continuous across different narrowband segments in UL transmission.

In some examples, before performing multiple FFT operations for wideband operations, the UE and the network may communicate one or more sets of configurations related to the multiple FFT operations. For example, the UE may receive an indication to report the capability to handle one or more first configuration sets to the network. In some examples, the one or more first configuration sets may be one or more sets of (N₁, N₂) values. N₁ may represent the minimum time duration from decoding PDCCH to a readiness for the reception of PDSCH. N₂ may represent the minimum time duration from decoding PDCCH to a readiness for PUSCH transmission. N₁ and N₂ may be determined by UE capability.

In some aspects, the network may configure one or more second configuration sets for performing multiple FFT operations to the UE based on the UE's capability report. For example, the one or more second configuration sets may include one or more sets of (K₀, K₁, K₂) values. K₀ may indicate the number of time slots between PDCCH/DCI and DL data (PDSCH) transmission. For example, if DCI and a PDSCH are in the same slot, K₀ may be 0. K₁ may indicate the number of time slots between a PDSCH and HARQ ACK/NACK transmission, and K₂ may indicate the number of time slots between a PDCCH/DCI and an UL data (PUSCH) transmission.

The first configuration set and the second configuration set for performing multiple FFT operations may be set differently in relation to multiple FFT operations. In one configuration, the first configuration set (e.g., the values (N₁′, N₂′)) and the second configuration set (e.g., the values (K₀′, K₁′, K₂′)) for multiple FFT operations for wideband operations may be the same as those for a single FFT operation for narrowband operation. In another configuration, at least one of the first configuration set (e.g., the values (N₁′, N₂′)) and the second configuration set (e.g., the values (K₀′, K₁′, K₂′)) for multiple FFT operations for wideband operations may be different from at least one of the first configuration set (e.g., the values (N₁, N₂)) and the second configuration set (e.g., the values (K₀, K₁, K₂)) for performing a single FFT operation for a narrowband operation. On the other hand, the first configuration set (e.g., the values of (N₁′, N₂′)) and the second configuration set (e.g., the values of (K₀′, K₁′, K₂′)) for multiple FFT operations may be the same for different numbers of the multiple FFT operations. In another configuration, at least one of the first configuration set (e.g., the values of (N₁′, N₂′)) and the second configuration set (e.g., the values of (K₀′, K₁′, K₂′)) for multiple FFT operations may be different for a different number of the FFT operations.

In some examples, at least one of the first configuration set (e.g., the values of (N₁′, N₂′)) and the second configuration set (e.g., the values of (K₀′, K₁′, K₂′)) for multiple FFT operations may vary depending on whether the phase alignment and concatenation function (550) is enabled or disabled.

In some aspects, when performing multiple FFT operations for wideband operations, there may be specific considerations for the physical resource block (PRB) group (PRG) grid definition, especially for low-tier UEs. Low-tier UEs may not support the phase alignment and concatenation function (e.g., 550), which may lead to phase glitches between each extracted narrowband segment. These phase glitches may occur in the middle of a PRG, thereby necessitating a more complex orphan PRG (e.g., a scenario where a PRG does not align well with the signal processing configurations of a UE) processing by the UE.

In some aspects, the network may configure the PRG size based on the UE's capability report, so that the PRG boundary is aligned with the maximum continuous narrowband bandwidth boundary. The primary benefit of this approach is the reduction of complexity on the UE side due to the fixed narrowband bandwidth extraction.

In some aspects, the network may configure both the PRG size and the narrowband bandwidth based on the UE's capability report, so that the PRG boundary is aligned with the configured continuous narrowband bandwidth boundary. The advantage of this approach is that it allows for more dynamic scheduling from the network's perspective. The PRG configurations are applicable in managing the varying capabilities of different UEs, particularly in the context of both DL PRG and UL PRG.

In some aspects, when performing multiple FFT operations for wideband operations, there are specific considerations for the wideband channel state information-reference signal (CSI-RS), especially for low-tier UEs. Low-tier UEs may not support the phase alignment and concatenation function (e.g., 550), which may result in phase glitches between each extracted narrowband segment. These phase glitches may happen in the middle of a wideband CSI-RS.

To mitigate this issue, in some aspects, the network may configure the size of the CSI-RS subband based on the UE's capability report. This configuration may ensure that the boundary of the CSI-RS subband size is aligned with the boundary of the maximum continuous narrowband bandwidth. The advantage of this approach is a reduced complexity on the UE side, due to the fixed narrowband bandwidth extraction.

In some aspects, the network may configure both the CSI-RS subband size and the narrowband bandwidth based on the UE's capability report. This configuration may ensure that the boundary of the CSI-RS subband size is aligned with the boundary of the configured continuous narrowband bandwidth. The advantage of this approach is the facilitation of a more dynamic scheduling from the network's perspective.

The multiple FFT operations for wideband operations may be applicable to various use cases. In some examples, the multiple FFT operations may be applicable for DL and UL data transmissions with high data rates, where wideband may provide ample resources for effective management of the high data rate transmissions. In some examples, the multiple FFT operations may be applicable for DL or UL reference signal transmissions, commonly used in applications such as positioning and sensing. In these scenarios, the wideband may be beneficial for achieving high resolution, thus enhancing the accuracy and effectiveness of these applications.

In some aspects, although the UE may support multiple FFT operations for wideband operations, the UE may indicate to the network that it does not support physical downlink control channel (PDCCH) blind detection in the wideband context, and the input wideband signal (e.g., WB TD signal 502) may not include a PDCCH transmission. This indication may facilitate UE power conservation. By indicating the limitations in PDCCH blind detection (e.g., a process where a UE detects relevant control information without prior knowledge of the exact location of the control information), the power usage in UEs may be optimized while leveraging the benefits of wideband operations through multiple FFT operations.

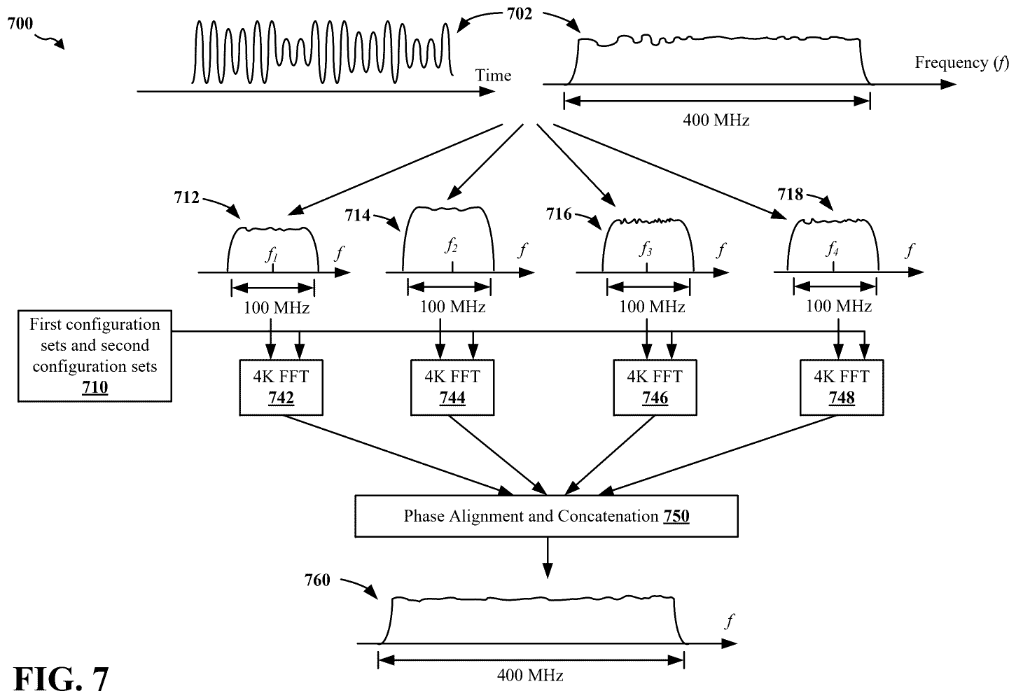

FIG. 7 is a diagram 700 illustrating an example of employing multiple FFT operations on a wideband signal in accordance with various aspects of the present disclosure. In FIG. 7, the process begins with the UE obtaining a first wideband signal 702. If multiple FFT operations are utilized for DL reception, the UE may receive the first wideband signal 702 from a base station. The first wideband signal 702 may have a continuous wideband bandwidth (e.g., no guard bands within the continuous wideband bandwidth) of 400 MHz, for example. The UE may separate the first wideband signal 702 into multiple narrowband segments (e.g., 712, 714, 716, 718). This separation may be achieved by, for example, passing the first wideband signal 702 through the digital processing chain 504 and applying frequency shift and a LPF (e.g., at 522, 524, 526, and 528). As a result, each of the multiple narrowband segments may have a narrowband bandwidth (e.g., 100 MHz) less than the continuous wideband bandwidth (e.g., 400 MHz) of the first wideband signal 702, and may have different frequency shifts. For example, in FIG. 7, the center frequencies of the narrowband segments (e.g., f₁, f₂, f₃, and f₄) may differ by 100 MHz.

The next stage may involve the UE performing FFT operations (at 742, 744, 746, and 748) on these narrowband segments (e.g., 712, 714, 716, 718). The FFT operations on the narrowband segments may have a smaller input size (e.g., 4K FFT) compared to what may be used for a single FFT on the entire wideband signal 702 (e.g., 16K FFT). The FFT operations (at 742, 744, 746, and 748) may be performed based on the first configuration sets and the second configuration sets 710. In some examples, the first configuration sets may include one or more sets of (N₁, N₂) values. N₁ may represent the minimum time duration from decoding a PDCCH to a readiness for the reception of PDSCH, and N₂ may represent the minimum time duration from decoding a PDCCH to a readiness for PUSCH transmission. N₁ and N₂ may be determined by UE capability. In some examples, the second configuration sets may include one or more sets of (K₀, K₁, K₂) values. K₀ may indicate the number of time slots between a PDCCH/DCI and DL data (PDSCH) transmission. For example, if DCI and PDSCH are in the same slot, K₀ may be 0. K₁ may indicate the number of time slots between a PDSCH and HARQ ACK/NACK transmission, and K₂ may indicate the number of time slots between a PDCCH/DCI and UL data (PUSCH) transmission.

Following the FFT operations (at 742, 744, 746, and 748), the UE may combine the processed segments after the FFT operations to form a second wideband signal 760. In some examples, if supported by the UE's capability, the UE may apply the phase alignment and concatenation function 750 on the processed segments. The phase alignment and concatenation function 750 may include phase alignment and concatenation on the processed segments to ensure a continuous phase across the continuous wideband bandwidth of the second wideband signal 760.

In some examples, the UE may communicate its capability for performing multiple FFT operations on the multiple narrowband segments to the base station by sending a wideband capability indicator. The UE's capability may include the maximum continuous wideband (e.g., 400 MHz), the maximum continuous narrowband bandwidth (e.g., 100 MHz), and the maximum number of FFT operations (e.g., 4 FFT operations) the UE may support. The maximum continuous wideband, the maximum continuous narrowband bandwidth, and the maximum number of FFT operations may be related to DL reception, UL transmission, or a combination of DL reception and UL transmission. In some examples, the wideband capability indicator may further indicate whether the UE supports the phase alignment and concatenation function 750.

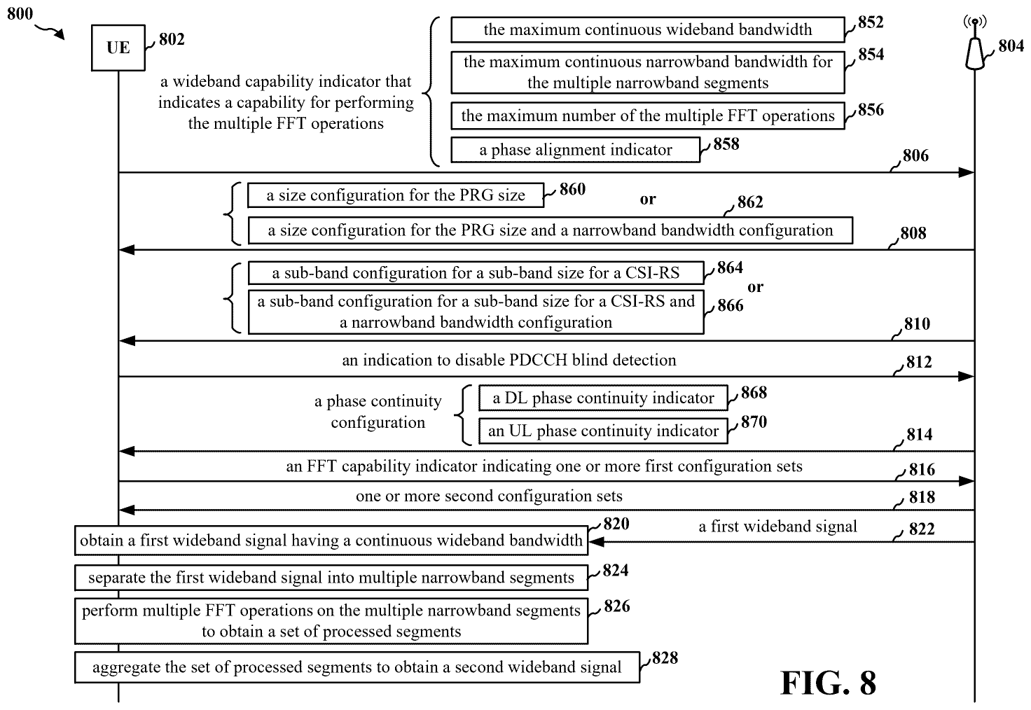

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., a CU 110, a DU 130, and/or an RU 140).

As shown in FIG. 8, at 806, a UE 802 may transmit a wideband capability indictor to the base station 804. The wideband capability may indicate the capability of the UE 802 for performing multiple FFT operations on multiple narrowband segments (which may be obtained from a wideband signal, such as the WB TD signal 502) to obtain a set of processed segments. The capabilities for performing multiple FFT operations may include one or more of the following: the maximum continuous wideband bandwidth (852) supported in DL reception, UL transmission, or a combination of the DL reception and the UL transmission, the maximum continuous narrowband bandwidth (854) supported for the multiple narrowband segments supported for each of the multiple FFT operations in the DL reception, the UL transmission, or a combination of the DL reception and the UL transmission, or the maximum number of the multiple FFT operations (856) supported in the DL reception, the UL transmission, or a combination of the DL reception and the UL transmission. In some examples, the capabilities for performing multiple FFT operations may further include a phase alignment indicator 858. The phase alignment indicator 858 may indicate whether the UE supports a phase alignment and concatenation operation (e.g., at 550) after the multiple FFT operations. The phase alignment and concatenation operation may include performing alignment and concatenation on multiple narrowband segments to obtain a processed wideband signal, such as the WB FD signal 560, having a continuous phase across the continuous wideband bandwidth of the processed wideband signal.

At 808, in some aspects, the UE 802 may receive a size configuration for a PRG size (860) from the base station 804. The size configuration may ensure that the PRG boundary of the PRG is aligned with a boundary of the maximum continuous narrowband bandwidth of the multiple narrowband segments. Alternatively, in some aspects, at 808, the UE 802 may receive the size configuration for the PRG size and a narrowband bandwidth configuration (862) from the base station 804. The narrowband bandwidth configuration may be applicable for a continuous narrowband bandwidth of each of the multiple narrowband segments, and may ensure that the PRG boundary of the PRG is aligned with the boundary of the continuous narrowband bandwidth.

At 810, in some aspects, the UE 802 may receive a sub-band configuration for a sub-band size for a CSI-RS (864) from the base station 804. The sub-band configuration may ensure that the sub-band boundary of a sub-band of the CSI-RS may be aligned with the boundary of the maximum continuous narrowband bandwidth of the multiple narrowband segments. Alternatively, in some aspects, at 810, the UE 802 may receive a sub-band configuration for a sub-band size for a CSI-RS and a narrowband bandwidth configuration (866) from the base station 804. The narrowband bandwidth configuration may be applicable for a continuous narrowband bandwidth of each of the multiple narrowband segments, and may ensure that the sub-band boundary of a sub-band of the CSI-RS is aligned with the boundary of the continuous narrowband bandwidth.

At 812, the UE 802 may transmit an indication to disable PDCCH blind detection to the base station 804. In response to the indication, when the base station 804 transmits a first wideband signal to the UE 802 (at 820), the first wideband signal may not include a PDCCH transmission.

At 814, the phase alignment indicator (858) may indicate the UE 802 supports the phase alignment and concatenation operation (e.g., at 550), and the UE 802 may receive a phase continuity configuration from the base station 804. The phase continuity configuration may include one or more of: a DL phase continuity indicator (868) indicating a first phase continuity for the first wideband signal (the base station transmits at 820), or an UL phase continuity indicator (870) indicating a phase continuity condition for the second wideband signal (e.g., the second wideband signal at 828 or the WB FD signal 560). For example, the DL phase continuity indicator (868) may indicate the first phase continuity across the multiple narrowband segments of the first wideband signal (e.g., the WB TD signal 502), and the UL phase continuity indicator (870) may indicate the phase continuity condition across multiple output narrowband segments of the second wideband signal (e.g., the WB FD signal 560). In some aspects, the UE 802 may receive the phase continuity configuration from the base station 804 via one of: RRC signaling, a medium access control (MAC)-control element (MAC-CE), or DCI.

At 816, the UE 802 may transmit an FFT capability indicator to the base station 804. The FFT capability indicator may indicate one or more first configuration sets associated with minimum time durations for the multiple FFT operations (at 824). For example, the minimum time durations may include the minimum time duration from decoding PDCCH to readiness for PDSCH reception, and the minimum time duration from decoding PDCCH to readiness for PUSCH transmission. The minimum time durations may be determined by UE capability.

At 818, the UE 802 may receive, from the base station 804 based on the FFT capability indicator (at 816), one or more second configuration sets associated with the number of time slots for the multiple FFT operations (at 824). The one or more second configuration sets may be based on the one or more first configuration sets, and the UE 802 may perform multiple FFT operations (at 824) based on the one or more first configuration sets and the one or more second configuration sets. The number of time slots for the multiple FFT operations (at 824) may include, for example, a first number of time slots between PDCCH/DCI and downlink data (e.g., PDSCH) transmission. For example, if DCI and PDSCH are in the same slot, the first number of time slot may be 0. The numbers of time slots may further include a second number of time slots between PDSCH and HARQ Acknowledgement (ACK)/Negative Acknowledgement (NACK) (ACK/NACK) transmission, and a third number of time slots between PDCCH/DCI and uplink data (e.g., PUSCH) transmission.

At 820, the UE 802 may obtain a first wideband signal. The first wideband signal may have a continuous wideband bandwidth (e.g., no guard band within the wideband bandwidth of the first wideband signal). For example, the first wideband signal may be the WB TD signal 502. In some aspects, the UE 802 may obtain the first wideband signal from the base station 804 (at 822).

At 824, the UE 802 may separate the first wideband signal into multiple narrowband segments. Each of the multiple narrowband segments may have a narrowband bandwidth less than the continuous wideband bandwidth, and multiple narrowband segments may have different frequency shifts. For example, referring to FIG. 5, the first wideband signal (the WB TD signal 502) may be divided into four narrowband segments (at 512, 514, 516, and 518). Each of the multiple narrowband segments may have a narrowband bandwidth (e.g., 100 MHz) less than the continuous wideband bandwidth (e.g., 400 MHz), and the frequency shift for each narrowband segment may differ by 100 MHz.

At 826, the UE 802 may perform multiple FFT operations (e.g., at 542, 544, 546, 548) on the multiple narrowband segments to obtain a set of processed segments respectively corresponding to the multiple narrowband segments.

At 828, the base station 804 may aggregate the set of processed segments to obtain a second wideband signal (e.g., the WB FD signal 560). In some examples, if the UE 802 supports the phase alignment and concatenation operation after the multiple FFT operations, the UE 802 may perform the alignment and concatenation operation (e.g., at 560) on the multiple narrowband segments to obtain the second wideband signal, and the second wideband signal may have a continuous phase across the continuous wideband bandwidth.

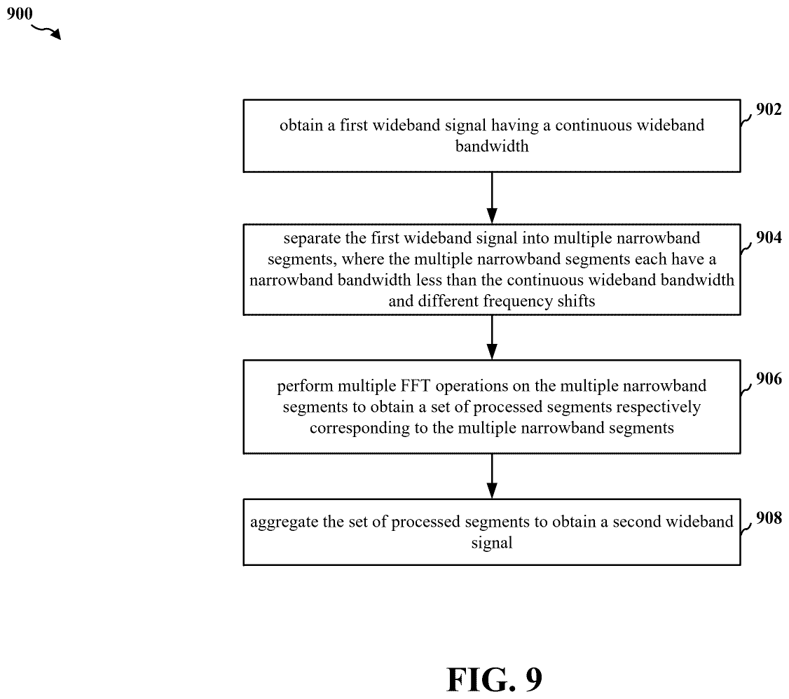

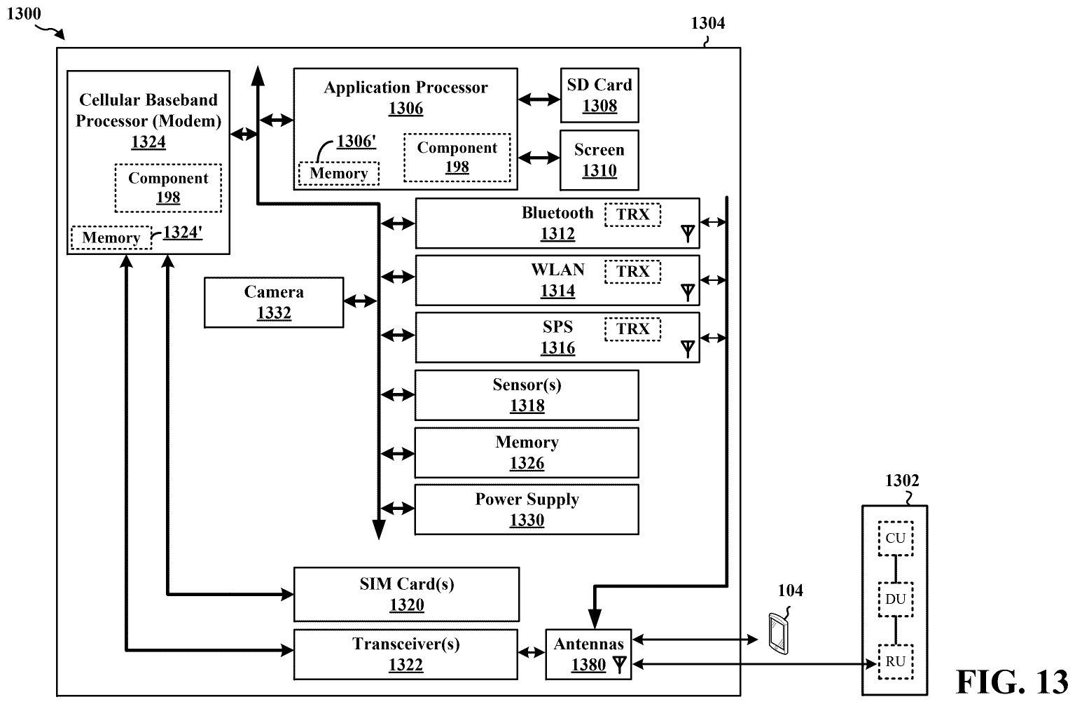

FIG. 9 is a flowchart 900 illustrating methods of wireless communication at a UE in accordance with various aspects of the present disclosure. The method may be performed by a UE. The UE may be the UE 104, 350, 802, or the apparatus 1304 in the hardware implementation of FIG. 13. The methods allow the UE to divide a wideband signal into multiple narrowband segments and subsequently perform multiple FFT operations on these narrowband segments, as opposed to conducting a single FFT operation on the entire wideband signal. Hence, the methods allow for more efficient processing of wideband signals to accommodate a variety of use cases. In some examples, the methods incorporate a phase alignment and concatenation function to ensure phase continuity across the wideband bandwidth and allow the removal of guard bands within the wideband bandwidth. Hence, the methods enhance the resource efficiency of wireless communication.

As shown in FIG. 9, at 902, the UE may obtain a first wideband signal having a continuous wideband bandwidth. The network entity may be a base station, or a component of a base station, in the access network of FIG. 1 or a core network component (e.g., base station 102, 310, 804; or the network entity 1302 in the hardware implementation of FIG. 13). FIGS. 5, 6, 7, and 8 illustrate various aspects of the steps in connection with flowchart 900. For example, referring to FIG. 8, the UE 802 may, at 820, obtain a first wideband signal having a continuous wideband bandwidth. In the example in FIG. 5, the first wideband signal may be the WB TD signal 502, which has a continuous wideband bandwidth of 400 MHz. In some aspects, 902 may be performed by the wideband FFT component 198.

At 904, the UE may separate the first wideband signal into multiple narrowband segments. The multiple narrowband segments each have a narrowband bandwidth less than the continuous wideband bandwidth and different frequency shifts. For example, referring to FIG. 8, the UE 802 may, at 824, separate the first wideband signal into multiple narrowband segments. Referring to FIG. 5, the first wideband signal (the WB TD signal 502) may be divided into four narrowband segments (at 512, 514, 516, and 518). Each of the multiple narrowband segments may have a narrowband bandwidth (e.g., 100 MHz) less than the continuous wideband bandwidth (e.g., 400 MHz). Referring to FIG. 7, the center frequencies of the narrowband segments (e.g., f₁, f₂, f₃, and f₄) may differ by 100 MHz. In some aspects, 904 may be performed by the wideband FFT component 198.

At 906, the UE may perform multiple FFT operations on the multiple narrowband segments to obtain a set of processed segments respectively corresponding to the multiple narrowband segments. For example, referring to FIG. 8, the UE 802 may, at 826, perform multiple FFT operations on the multiple narrowband segments to obtain a set of processed segments respectively corresponding to the multiple narrowband segments. Referring to FIG. 5, the UE may perform multiple FFT operations (e.g., at 542, 544, 546, 548) on the multiple narrowband segments to obtain a set of processed segments respectively corresponding to the multiple narrowband segments. In some aspects, 906 may be performed by the wideband FFT component 198.

At 908, the UE may aggregate the set of processed segments to obtain a second wideband signal. For example, referring to FIG. 5 and FIG. 8, the UE 802 may, at 828, aggregate the set of processed segments to obtain a second wideband signal (e.g., the WB FD signal 560). In some aspects, 908 may be performed by the wideband FFT component 198.

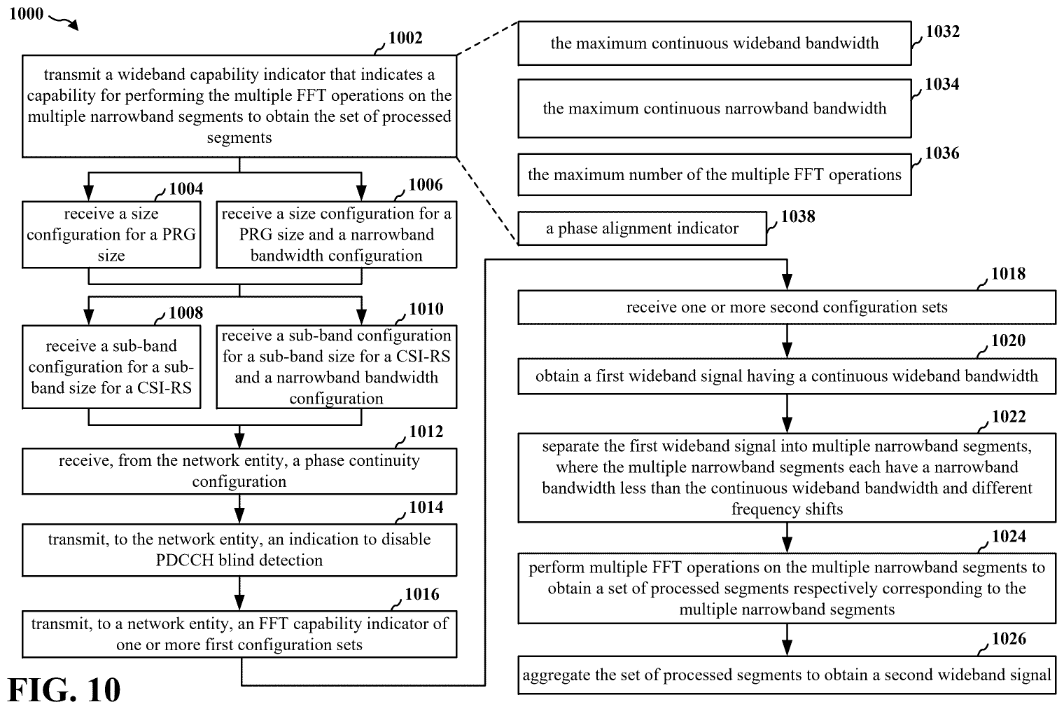

FIG. 10 is a flowchart 1000 illustrating methods of wireless communication at a UE in accordance with various aspects of the present disclosure. The method may be performed by a UE. The UE may be the UE 104, 350, 802, or the apparatus 1304 in the hardware implementation of FIG. 13. The methods allow the UE to divide a wideband signal into multiple narrowband segments and subsequently perform multiple FFT operations on these narrowband segments, as opposed to conducting a single FFT operation on the entire wideband signal. Hence, the methods allow for more efficient processing of wideband signals to accommodate a variety of use cases. In some examples, the methods incorporate a phase alignment and concatenation function to ensure phase continuity across the wideband bandwidth and allow the removal of guard bands within the wideband bandwidth. Hence, the methods enhance the resource efficiency of wireless communication.

As shown in FIG. 10, at 1020, the UE may obtain a first wideband signal having a continuous wideband bandwidth. The network entity may be a base station, or a component of a base station, in the access network of FIG. 1 or a core network component (e.g., base station 102, 310, 804; or the network entity 1302 in the hardware implementation of FIG. 13). FIGS. 5, 6, 7, and 8 illustrate various aspects of the steps in connection with flowchart 1000. For example, referring to FIG. 8, the UE 802 may, at 820, obtain a first wideband signal having a continuous wideband bandwidth. In the example in FIG. 5, the first wideband signal may be the WB TD signal 502, which has a continuous wideband bandwidth of 400 MHz. In some aspects, 1020 may be performed by the wideband FFT component 198.

At 1022, the UE may separate the first wideband signal into multiple narrowband segments. The multiple narrowband segments each have a narrowband bandwidth less than the continuous wideband bandwidth and different frequency shifts. For example, referring to FIG. 8, the UE 802 may, at 824, separate the first wideband signal into multiple narrowband segments. Referring to FIG. 5, the first wideband signal (the WB TD signal 502) may be divided into four narrowband segments (at 512, 514, 516, and 518). Each of the multiple narrowband segments may have a narrowband bandwidth (e.g., 100 MHz) less than the continuous wideband bandwidth (e.g., 400 MHz Referring to FIG. 7, the center frequencies of the narrowband segments (e.g., f₁, f₂, f₃, and f₄) may differ by 100 MHz. In some aspects, 1022 may be performed by the wideband FFT component 198.

At 1024, the UE may perform multiple FFT operations on the multiple narrowband segments to obtain a set of processed segments respectively corresponding to the multiple narrowband segments. For example, referring to FIG. 8, the UE 802 may, at 826, perform multiple FFT operations on the multiple narrowband segments to obtain a set of processed segments respectively corresponding to the multiple narrowband segments. Referring to FIG. 5, the UE may perform multiple FFT operations (e.g., at 542, 544, 546, 548) on the multiple narrowband segments to obtain a set of processed segments respectively corresponding to the multiple narrowband segments. In some aspects, 1024 may be performed by the wideband FFT component 198.

At 1026, the UE may aggregate the set of processed segments to obtain a second wideband signal. For example, referring to FIG. 5 and FIG. 8, the UE 802 may, at 828, aggregate the set of processed segments to obtain a second wideband signal (e.g., the WB FD signal 560). In some aspects, 1026 may be performed by the wideband FFT component 198.

In some aspects, there may be no guard band located between the continuous wideband bandwidth of the first wideband signal. For example, referring to FIG. 5 and FIG. 6, there may be no guard band located between the continuous wideband bandwidth of the WB TD signal 502 or the wideband signal 602.

In some aspects, the continuous wideband bandwidth (at 1020) may be greater than or equal to 400 MHz, and each of the multiple FFT operations (at 1024) may have a first input size that is less than or equal to 4096. For example, referring to FIG. 5, the continuous wideband bandwidth (e.g., the wideband of the WB TD signal 502) may be greater than or equal to 400 MHz, and each of the multiple FFT operations (e.g., 542, 544, 546, and 548) may have a first input size that is less than or equal to 4096.

In some aspects, at 1002, the UE may transmit, to a network entity, a wideband capability indicator that indicates the capability for performing multiple FFT operations on the multiple narrowband segments to obtain the set of processed segments (at 1024). For example, referring to FIG. 5 and FIG. 8, the UE 802 may transmit, at 806 to a network entity (base station 804), a wideband capability indicator. The indicator may indicate the UE's capability for performing multiple FFT operations (e.g., at 542, 544, 546, and 548) on the multiple narrowband segments to obtain the set of processed segments. In some aspects, 1002 may be performed by the wideband FFT component 198.

In some aspects, the capability may include one or more of: the maximum continuous wideband bandwidth (1032) supported in DL reception, UL transmission, or a combination of the DL reception and the UL transmission, the maximum continuous narrowband bandwidth (1034) for the multiple narrowband segments supported for each of the multiple FFT operations in the DL reception, the UL transmission, or a combination of the DL reception and the UL transmission, or the maximum number of the multiple FFT operations (1036) supported in the DL reception, the UL transmission, or a combination of the DL reception and the UL transmission. For example, referring to FIG. 8, the capability may include one or more of: the maximum continuous wideband bandwidth (852) supported in DL reception, UL transmission, or a combination of the DL reception and the UL transmission, the maximum continuous narrowband bandwidth (854) for the multiple narrowband segments supported for each of the multiple FFT operations in the DL reception, the UL transmission, or a combination of the DL reception and the UL transmission, or the maximum number of the multiple FFT operations (856) supported in the DL reception, the UL transmission, or a combination of the DL reception and the UL transmission.

In some aspects, the wideband capability indicator (at 1002) may further include: a phase alignment indicator (1038) that indicates a support or a lack of the support for performing a phase alignment and concatenation operation after the multiple FFT operations. The phase alignment and concatenation operation may include an alignment and concatenation of the multiple narrowband segments to obtain the second wideband signal, and the second wideband signal may have a continuous phase across the continuous wideband bandwidth. For example, referring to FIG. 5 and FIG. 8, the wideband capability indicator (at 806) may further include a phase alignment indicator 858 that indicates whether the UE supports a phase alignment and concatenation operation (e.g., at 550) after the multiple FFT operations (e.g., at 542, 544, 546, and 548). The phase alignment and concatenation operation may include an alignment and concatenation of the multiple narrowband segments to obtain the second wideband signal (e.g., the WB FD signal 560), and the second wideband signal (e.g., the WB FD signal 560) may have a continuous phase across the continuous wideband bandwidth.

In some aspects, at 1004, the UE may receive, from the network entity, a size configuration for a physical resource block (PRB) group (PRG) size. The PRG boundary of the PRG may be aligned with a boundary of a maximum continuous narrowband bandwidth of the multiple narrowband segments. For example, referring to FIG. 8, the UE 802 may receive, at 808 from the network entity (base station 804), a size configuration for a PRG size 860. The size configuration may ensure that the PRG boundary of the PRG is aligned with the boundary of the maximum continuous narrowband bandwidth of the multiple narrowband segments. In some aspects, 1004 may be performed by the wideband FFT component 198.

In some aspects, at 1006, the UE may receive, from the network entity, a size configuration for the PRG size and a narrowband bandwidth configuration for a continuous narrowband bandwidth of each of the multiple narrowband segments. The PRG boundary of the PRG may be aligned with a boundary of the continuous narrowband bandwidth. For example, referring to FIG. 8, the UE 802 may receive, at 808 from the network entity (base station 804), a size configuration for the PRG size and a narrowband bandwidth configuration (862) for a continuous narrowband bandwidth of each of the multiple narrowband segments. The PRG boundary of the PRG may be aligned with a boundary of the continuous narrowband bandwidths. In some aspects, 1006 may be performed by the wideband FFT component 198.

In some aspects, at 1008, the UE may receive, from the network entity, a sub-band configuration for a sub-band size for a channel state information-reference signal (CSI-RS). The sub-band boundary of a sub-band of the CSI-RS may be aligned with a boundary of a maximum continuous narrowband bandwidth of the multiple narrowband segments. For example, referring to FIG. 8, the UE 802 may receive, at 810 from the network entity (base station 804), a sub-band configuration for the sub-band size for a CSI-RS 864. The sub-band configuration may ensure that the sub-band boundary of the sub-band of the CSI-RS is aligned with the boundary of the maximum continuous narrowband bandwidth of the multiple narrowband segments. In some aspects, 1008 may be performed by the wideband FFT component 198.

In some aspects, at 1010, the UE may receive, from the network entity, a sub-band configuration for a sub-band size for the CSI-RS and a narrowband bandwidth configuration for a continuous narrowband bandwidth of each of the multiple narrowband segments. The sub-band boundary of a sub-band of the CSI-RS may be aligned with a boundary of the continuous narrowband bandwidth. For example, referring to FIG. 8, the UE 802 may receive, at 810 from the network entity (base station 804), a sub-band configuration for the sub-band size for the CSI-RS and a narrowband bandwidth configuration (866) for a continuous narrowband bandwidth of each of the multiple narrowband segments. The sub-band boundary of the sub-band of the CSI-RS may be aligned with the boundary of the continuous narrowband bandwidths. In some aspects, 1010 may be performed by the wideband FFT component 198.

In some aspects, the phase alignment indicator (1038) may indicate the support for performing the phase alignment and concatenation operation. At 1012, the UE may receive, from the network entity, a phase continuity configuration. The phase continuity configuration may include one or more of: a DL phase continuity indicator indicating a first phase continuity for the first wideband signal, or an UL phase continuity indicator indicating a phase continuity condition for the second wideband signal. For example, referring to FIG. 8, the UE 802 may receive, at 814 from the network entity (base station 804), a phase continuity configuration. The phase continuity configuration may include one or more of: a DL phase continuity indicator 868 indicating a first phase continuity for the first wideband signal, or an UL phase continuity indicator 870 indicating a phase continuity condition for the second wideband signal. In some aspects, 1012 may be performed by the wideband FFT component 198.

In some aspects, the DL phase continuity indicator may indicate the first phase continuity across the multiple narrowband segments of the first wideband signal. For example, referring to FIG. 5 and FIG. 8, the DL phase continuity indicator 868 may indicate the first phase continuity across the multiple narrowband segments of the first wideband signal (e.g., the WB TD signal 502).

In some aspects, the UL phase continuity indicator may indicate the phase continuity condition across multiple output narrowband segments of the second wideband signal. For example, referring to FIG. 5 and FIG. 8, the UL phase continuity indicator 870 may indicate the phase continuity condition across multiple output narrowband segments of the second wideband signal (e.g., the WB FD signal 560).

In some aspects, the UE may receive the phase continuity configuration (at 1012) via one of: radio resource control (RRC) signaling, a medium access control (MAC)-control element (MAC-CE), or downlink control information (DCI). For example, referring to FIG. 8, the UE 802 may receive, at 814, the phase continuity configuration via one of: RRC signaling, a MAC-CE, or DCI.

In some aspects, at 1014, the UE may transmit, to the network entity, an indication to disable PDCCH blind detection. The first wideband signal may not include a PDCCH transmission. For example, referring to FIG. 8, the UE 802 may transmit, at 812 to the network entity (base station 804), an indication to disable PDCCH blind detection, and the first wideband signal (at 822) may not include a PDCCH transmission. In some aspects, 1014 may be performed by the wideband FFT component 198.

In some aspects, the UE may, at 1016, transmit, to a network entity, an FFT capability indicator indicating one or more first configuration sets associated with minimum time durations for the multiple FFT operations, and, at 1018, receive, from the network entity based on the FFT capability indicator, one or more second configuration sets associated with the number of time slots for the multiple FFT operations. The one or more second configuration sets are based on the one or more first configuration sets. The UE may perform multiple FFT operations (at 1024) based on the one or more first configuration sets and the one or more second configuration sets. For example, referring to FIG. 5 and FIG. 8, the UE 802 may, at 816, transmit, to a network entity (base station 804), an FFT capability indicator indicating one or more first configuration sets associated with minimum time durations for the multiple FFT operations (e.g., at 542, 544, 546, 548). For example, the one or more first configuration sets may be one or more sets of (N₁, N₂) values. N₁ represents the minimum time duration from decoding PDCCH to readiness for the reception of PDSCH. N₂ represents the minimum time duration from decoding PDCCH to readiness for PUSCH transmission. The UE 802 may further receive, at 818 from the network entity (base station 804) based on the FFT capability indicator, one or more second configuration sets associated with the number of time slots for the multiple FFT operations. The one or more second configuration sets are based on the one or more first configuration sets. For example, the one or more second configuration sets may include one or more sets of (K₀, K₁, K₂) values. K₀ may indicate the number of time slots between PDCCH/DCI and DL data (PDSCH) transmission. K₁ may indicate the number of time slots between PDSCH and HARQ ACK/NACK transmission, and K₂ may indicate the number of time slots between PDCCH/DCI and UL data (PUSCH) transmission. Referring to FIG. 7, the UE may perform multiple FFT operations (at 742, 744, 746, 748) based on the one or more first configuration sets and the one or more second configuration sets 710. In some aspects, 1016 and 1018 may be performed by the wideband FFT component 198.

In some aspects, the multiple FFT operations and a single FFT operation for a narrowband signal may use the same first configuration set in the one or more first configuration sets and the same second configuration set in the one or more second configuration sets. For example, referring to FIG. 5, the first configuration set (e.g., the values of (N₁, N₂) and the second configuration set (e.g., the values of (K₀, K₁, K₂)) for multiple FFT operations (e.g., at 542, 544, 546, 548) for wideband operations may be the same as those for a single FFT operation for narrowband operation.

In some aspects, a first configuration set in the one or more first configuration sets for the multiple FFT operations may be different from another first configuration set in the one or more first configuration sets for a single FFT operation for a narrowband signal. The second configuration set in the one or more second configuration sets for the multiple FFT operations may be different from another second configuration set in the one or more second configuration sets for the single FFT operation for the narrowband signal. The first number of FFT operations of the multiple FFT operations and a second number of FFT operations of the multiple FFT operations may use the same first configuration set in the one or more first configuration sets and the same second configuration set in the one or more first configuration sets. For example, referring to FIG. 5, at least one of the first configuration set (e.g., the values of (N₁′, N₂′) and the second configuration set (e.g., the values of (K₀′, K₁′, K₂′)) for multiple FFT operations (e.g., at 542, 544, 546, 548) for wideband operations may be different from at least one of the first configuration set (e.g., the values of (N₁, N₂) and the second configuration set (e.g., the values of (K₀, K₁, K₂)) for performing a single FFT operation for a narrowband operation. On the other hand, the first configuration set (e.g., the values of (N₁′, N₂′) and the second configuration set (e.g., the values of (K₀′, K₁′, K₂′)) for multiple FFT operations (e.g., at 542, 544, 546, 548) may be the same for different numbers of the multiple FFT operations.

In some aspects, a first configuration set in the one or more first configuration sets for a first number of FFT operations of the multiple FFT operations may be different from another first configuration set in the one or more first configuration sets for a second number of FFT operations of the multiple FFT operations. A second configuration set in the one or more second configuration sets for the first number of FFT operations may be different from another second configuration set in the one or more second configuration sets for the second number of FFT operations. For example, referring to FIG. 5, at least one of the first configuration set (e.g., the values of (N₁′, N₂′) and the second configuration set (e.g., the values of (K₀′, K₁′, K₂′)) for multiple FFT operations (e.g., at 542, 544, 546, 548) may be different for different number of the FFT operations.

In some aspects, a first configuration set in the one or more first configuration sets for the multiple FFT operations with a phase alignment and concatenation operation may be different from another first configuration set in the one or more first configuration sets for the multiple FFT operations without the phase alignment and concatenation operation. A second configuration set in the one or more second configuration sets for the multiple FFT operations with the phase alignment and concatenation operation may be different from another second configuration set in the one or more second configuration sets for the multiple FFT operations without the phase alignment and concatenation operation. For example, referring to FIG. 5, at least one of the first configuration set (e.g., the values of (N₁′, N₂′) and the second configuration set (e.g., the values of (K₀′, K₁′, K₂′)) for multiple FFT operations (e.g., at 542, 544, 546, 548) may vary depending on whether the phase alignment and concatenation function (550) is enabled or disabled.

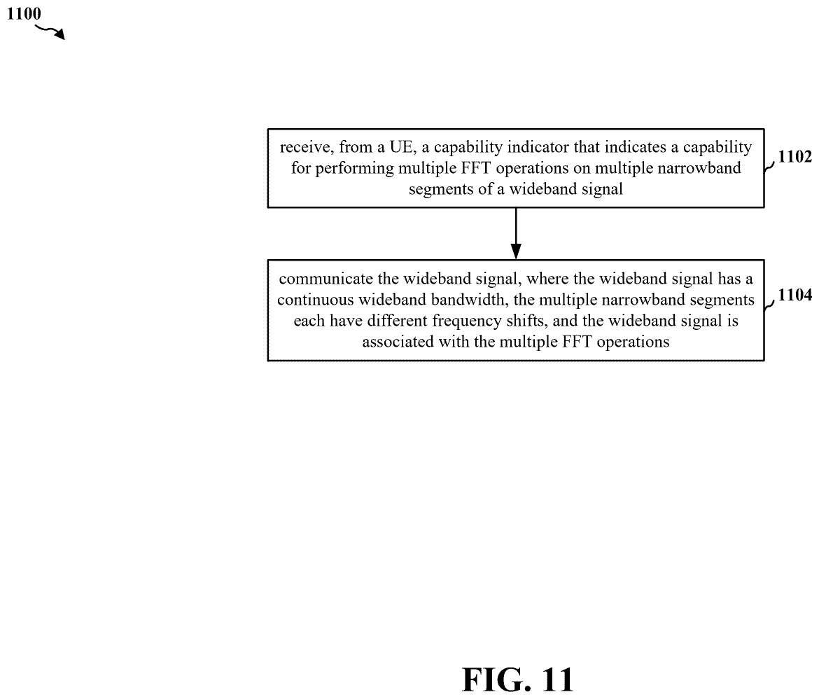

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The methods allow the UE to divide a wideband signal into multiple narrowband segments and subsequently perform multiple FFT operations on these narrowband segments, as opposed to conducting a single FFT operation on the entire wideband signal. Hence, the methods allow for more efficient processing of wideband signals to accommodate a variety of use cases. In some examples, the methods incorporate a phase alignment and concatenation function to ensure phase continuity across the wideband bandwidth and allow the removal of guard bands within the wideband bandwidth. Hence, the methods enhance the resource efficiency of wireless communication.

As shown in FIG. 11, at 1102, the network entity may receive, from a UE, a wideband capability indicator that indicates a capability for performing multiple FFT operations on multiple narrowband segments of a wideband signal. The UE may be the UE 104, 350, 802, or the apparatus 1304 in the hardware implementation of FIG. 13. FIGS. 5, 6, 7, and 8 illustrate various aspects of the steps in connection with flowchart 1100. For example, referring to FIG. 5 and FIG. 8, the network entity (base station 804) may receive, at 806 from a UE 802, a wideband capability indicator that indicates a capability for performing multiple FFT operations (e.g., 542, 544, 546, 548) on multiple narrowband segments of a wideband signal (e.g., WB TD signal 502). In some aspects, 1102 may be performed by the wideband FFT component 199.

At 1104, the network entity may communicate the wideband signal. The wideband signal may have a continuous wideband bandwidth. The multiple narrowband segments may each have different frequency shifts, and the wideband signal may be associated with the multiple FFT operations. For example, referring to FIG. 8, the network entity (base station 804) may communicate, at 822, the wideband signal (e.g., the first wideband signal). Referring to FIG. 5, the wideband signal (e.g., the WB TD signal 502) may have a continuous wideband bandwidth (e.g., 400 MHz). Referring to FIG. 7, the center frequencies of the narrowband segments (e.g., f₁, f₂, f₃, and f₄) may differ by 100 MHz, and the wideband signal may be associated with the multiple FFT operations (e.g., at 742, 744, 746, and 748). In some aspects, 1104 may be performed by the wideband FFT component 199.

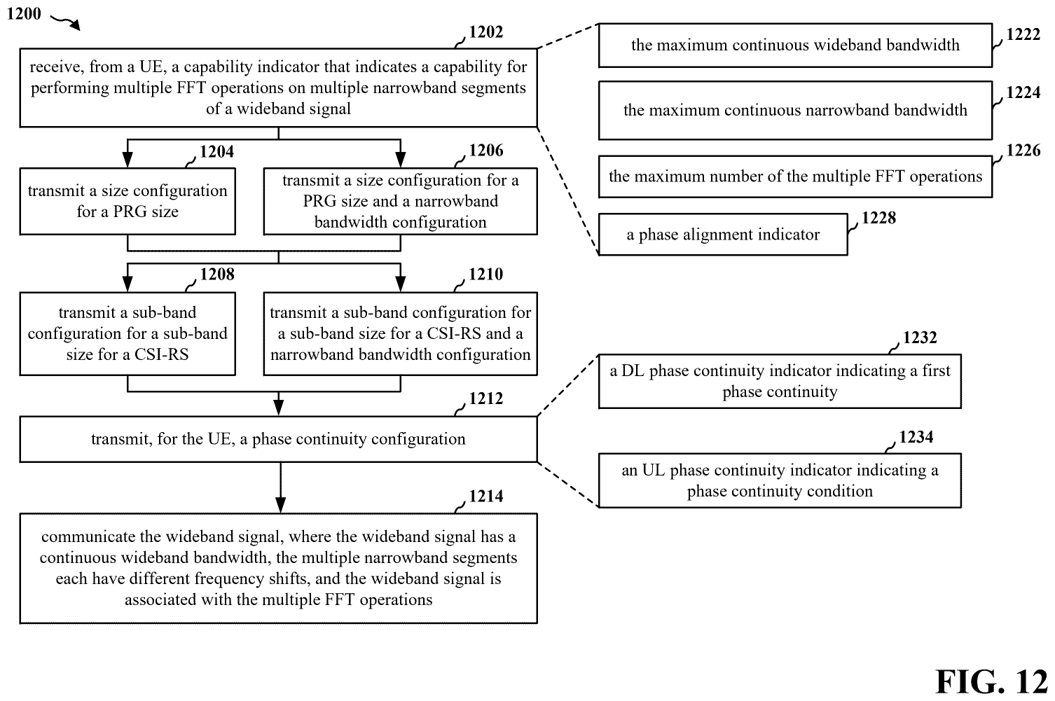

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The methods allow the UE to divide a wideband signal into multiple narrowband segments and subsequently perform multiple FFT operations on these narrowband segments, as opposed to conducting a single FFT operation on the entire wideband signal. Hence, the methods allow for more efficient processing of wideband signals to accommodate a variety of use cases. In some examples, the methods incorporate a phase alignment and concatenation function to ensure phase continuity across the wideband bandwidth and allow the removal of guard bands within the wideband bandwidth. Hence, the methods enhance the resource efficiency of wireless communication.

As shown in FIG. 12, at 1202, the network entity may receive, from a UE, a wideband capability indicator that indicates a capability for performing multiple FFT operations on multiple narrowband segments of a wideband signal. The UE may be the UE 104, 350, 802, or the apparatus 1304 in the hardware implementation of FIG. 13. FIGS. 5, 6, 7, and 8 illustrate various aspects of the steps in connection with flowchart 1200. For example, referring to FIG. 5 and FIG. 8, the network entity (base station 804) may receive, at 806 from a UE 802, a wideband capability indicator that indicates the UE's capability for performing multiple FFT operations (e.g., 542, 544, 546, 548) on multiple narrowband segments of a wideband signal (e.g., WB TD signal 502). In some aspects, 1202 may be performed by the wideband FFT component 199.

At 1214, the network entity may communicate the wideband signal. The wideband signal may have a continuous wideband bandwidth. The multiple narrowband segments may each have different frequency shifts, and the wideband signal may be associated with the multiple FFT operations. For example, referring to FIG. 8, the network entity (base station 804) may communicate, at 822, the wideband signal (e.g., the first wideband signal). Referring to FIG. 5, the wideband signal (e.g., the WB TD signal 502) may have a continuous wideband bandwidth (e.g., 400 MHz). Referring to FIG. 7, the center frequencies of the narrowband segments (e.g., f₁, f₂, f₃, and f₄) may differ by 100 MHz, and the wideband signal may be associated with the multiple FFT operations (e.g., at 742, 744, 746, and 748). In some aspects, 1214 may be performed by the wideband FFT component 199.

In some aspects, there may be no guard band located between the continuous wideband bandwidth of the wideband signal (at 1214). For example, referring to FIG. 5 and FIG. 6, there may be no guard band located between the continuous wideband bandwidth of the WB TD signal 502 or the wideband signal 602.

In some aspects, the continuous wideband bandwidth may be greater than or equal to 400 MHz, and each of the multiple FFT operations (at 1214) may have a first input size that is less than or equal to 4096. For example, referring to FIG. 5, the continuous wideband bandwidth (e.g., the wideband of the WB TD signal 502) may be greater than or equal to 400 MHz, and each of the multiple FFT operations (e.g., 542, 544, 546, and 548) may have a first input size that is less than or equal to 4096.

In some aspects, the capability (at 1202) may include one or more of: the maximum continuous wideband bandwidth (1222) supported in DL reception, UL transmission, or a combination of the DL reception and the UL transmission, the maximum continuous narrowband bandwidth (1224) supported for the multiple narrowband segments supported for each of the multiple FFT operations in the DL reception, the UL transmission, or a combination of the DL reception and the UL transmission, or the maximum number of the multiple FFT operations (1226) supported in the DL reception, the UL transmission, or a combination of the DL reception and the UL transmission. For example, referring to FIG. 8, the capability may include one or more of: the maximum continuous wideband bandwidth (852) supported in DL reception, UL transmission, or a combination of the DL reception and the UL transmission, the maximum continuous narrowband bandwidth (854) for the multiple narrowband segments supported for each of the multiple FFT operations in the DL reception, the UL transmission, or a combination of the DL reception and the UL transmission, or the maximum number of the multiple FFT operations (856) supported in the DL reception, the UL transmission, or a combination of the DL reception and the UL transmission.

In some aspects, the wideband capability indicator (at 1202) may further include: a phase alignment indicator (1228) that indicates a support or a lack of the support for performing a phase alignment and concatenation operation after the multiple FFT operations. The phase alignment and concatenation operation may include an alignment and concatenation of the multiple narrowband segments. For example, referring to FIG. 5 and FIG. 8, the wideband capability indicator (at 806) may further include a phase alignment indicator 858 that indicates whether the UE supports a phase alignment and concatenation operation (e.g., at 550) after the multiple FFT operations (e.g., at 542, 544, 546, and 548). The phase alignment and concatenation operation may include an alignment and concatenation of the multiple narrowband segments to obtain the second wideband signal (e.g., the WB FD signal 560), and the second wideband signal (e.g., the WB FD signal 560) may have a continuous phase across the continuous wideband bandwidth.

In some aspects, at 1204, the network entity may transmit, for the UE, a size configuration for a PRG size. The PRG boundary of the PRG is aligned with a boundary of a maximum continuous narrowband bandwidth of the multiple narrowband segments. Alternatively, at 1206, the network entity may transmit, for the UE, the size configuration for the PRG size and a narrowband bandwidth configuration for the continuous narrowband bandwidth of each of the multiple narrowband segments. The PRG boundary of the PRG may be aligned with a boundary of the continuous narrowband bandwidth. For example, referring to FIG. 8, the network entity (base station 804) may transmit, at 808 for the UE 802, a size configuration for a PRG size 860. The PRG boundary of the PRG is aligned with a boundary of a maximum continuous narrowband bandwidth of the multiple narrowband segments. Alternatively, the network entity (base station 804) may transmit, at 808 for the UE 802, the size configuration for the PRG size and a narrowband bandwidth configuration (862) for a continuous narrowband bandwidth of each of the multiple narrowband segments. The PRG boundary of the PRG may be aligned with the boundary of the continuous narrowband bandwidth. In some aspects, 1204 and 1206 may be performed by the wideband FFT component 199.

In some aspects, at 1208, the network entity may transmit, for the UE, a sub-band configuration for a sub-band size for a CSI-RS. The sub-band boundary of a sub-band of the CSI-RS may be aligned with a boundary of a maximum continuous narrowband bandwidth of the multiple narrowband segments. Alternatively, at 1210, the network entity may transmit, for the UE, the sub-band configuration for the sub-band size for the CSI-RS and a narrowband bandwidth configuration for a continuous narrowband bandwidth of each of the multiple narrowband segments. The sub-band boundary of a sub-band of the CSI-RS may be aligned with a boundary of the continuous narrowband bandwidth. For example, referring to FIG. 8, the network entity (base station 804) may transmit, at 810 for the UE 802, a sub-band configuration for a sub-band size for a CSI-RS 864. The sub-band boundary of the sub-band of the CSI-RS may be aligned with a boundary of a maximum continuous narrowband bandwidth of the multiple narrowband segments. Alternatively, the network entity (base station 804) may transmit, at 810 for the UE 802, the sub-band configuration for the sub-band size for the CSI-RS and a narrowband bandwidth configuration (866) for a continuous narrowband bandwidth of each of the multiple narrowband segments. The sub-band boundary of the sub-band of the CSI-RS may be aligned with a boundary of the continuous narrowband bandwidth. In some aspects, 1208 and 1210 may be performed by the wideband FFT component 199.

In some aspects, the phase alignment indicator (1228) may indicate the support for the phase alignment and concatenation operation. At 1212, the network entity may transmit, for the UE, a phase continuity configuration. The phase continuity configuration (at 1212) may include one or more of: a DL phase continuity indicator (1232) indicating a first phase continuity for the wideband signal, or an UL phase continuity indicator (1234) indicating a phase continuity condition for the wideband signal. For example, referring to FIG. 5 and FIG. 8, the phase alignment indicator (858) may indicate the UE supports the phase alignment and concatenation operation (at 550). The network entity (base station 804) may transmit, at 814 for the UE 802, a phase continuity configuration. The phase continuity configuration may include one or more of: a DL phase continuity indicator (868) indicating a first phase continuity for the wideband signal, or an UL phase continuity indicator (870) indicating a phase continuity condition for the wideband signal. In some aspects, 1212 may be performed by the wideband FFT component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor (or processing circuitry) 1324 (also referred to as a modem) coupled to one or more transceivers 1322 (e.g., cellular RF transceiver). The cellular baseband processor(s) (or processing circuitry) 1324 may include at least one on-chip memory (or memory circuitry) 1324′. In some aspects, the apparatus 1304 may further include one or more subscriber identity modules (SIM) cards 1320 and at least one application processor (or processing circuitry) 1306 coupled to a secure digital (SD) card 1308 and a screen 1310. The application processor(s) (or processing circuitry) 1306 may include on-chip memory (or memory circuitry) 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) (or processing circuitry) 1324 communicates through the transceiver(s) 1322 via one or more antennas 1380 with the UE 104 and/or with an RU associated with a network entity 1302. The cellular baseband processor(s) (or processing circuitry) 1324 and the application processor(s) (or processing circuitry) 1306 may each include a computer-readable medium/memory (or memory circuitry) 1324′, 1306′, respectively. The additional memory modules 1326 may also be considered a computer-readable medium/memory (or memory circuitry). Each computer-readable medium/memory (or memory circuitry) 1324′, 1306′, 1326 may be non-transitory. The cellular baseband processor(s) (or processing circuitry) 1324 and the application processor(s) (or processing circuitry) 1306 are each responsible for general processing, including the execution of software stored on the computer-readable medium/memory (or memory circuitry). The software, when executed by the cellular baseband processor(s) (or processing circuitry) 1324/application processor(s) (or processing circuitry) 1306, causes the cellular baseband processor(s) (or processing circuitry) 1324/application processor(s) (or processing circuitry) 1306 to perform the various functions described supra. The cellular baseband processor(s) (or processing circuitry) 1324 and the application processor(s) (or processing circuitry) 1306 are configured to perform the various functions described supra based at least in part of the information stored in the memory (or memory circuitry). That is, the cellular baseband processor(s) (or processing circuitry) 1324 and the application processor(s) (or processing circuitry) 1306 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1324/application processor(s) (or processing circuitry) 1306 when executing software. The cellular baseband processor(s) (or processing circuitry) 1324/application processor(s) (or processing circuitry) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) (or processing circuitry) 1324 and/or the application processor(s) (or processing circuitry) 1306, and in another configuration, the apparatus 1304 may be the entire UE (e.g., see UE 350 of FIG. 3) and include the additional modules of the apparatus 1304.

As discussed supra, the component 198 may be configured to obtain a first wideband signal having a continuous wideband bandwidth; separate the first wideband signal into multiple narrowband segments, where the multiple narrowband segments each have a narrowband bandwidth less than the continuous wideband bandwidth and different frequency shifts; perform multiple FFT operations on the multiple narrowband segments to obtain a set of processed segments respectively corresponding to the multiple narrowband segments; and aggregate the set of processed segments to obtain a second wideband signal. The component 198 may be further configured to perform any of the aspects described in connection with the flowcharts in FIG. 9 and FIG. 10, and/or performed by the UE 802 in FIG. 8. The component 198 may be within the cellular baseband processor(s) (or processing circuitry) 1324, the application processor(s) (or processing circuitry) 1306, or both the cellular baseband processor(s) (or processing circuitry) 1324 and the application processor(s) (or processing circuitry) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) (or processing circuitry) 1324 and/or the application processor(s) (or processing circuitry) 1306, includes means for obtaining a first wideband signal having a continuous wideband bandwidth, means for separating the first wideband signal into multiple narrowband segments, where the multiple narrowband segments each have a narrowband bandwidth less than the continuous wideband bandwidth and different frequency shifts, means for performing multiple FFT operations on the multiple narrowband segments to obtain a set of processed segments respectively corresponding to the multiple narrowband segments, and means for aggregating the set of processed segments to obtain a second wideband signal. The apparatus 1304 may further include means for performing any of the aspects described in connection with the flowcharts in FIG. 9 and FIG. 10, and/or aspects performed by the UE 802 in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

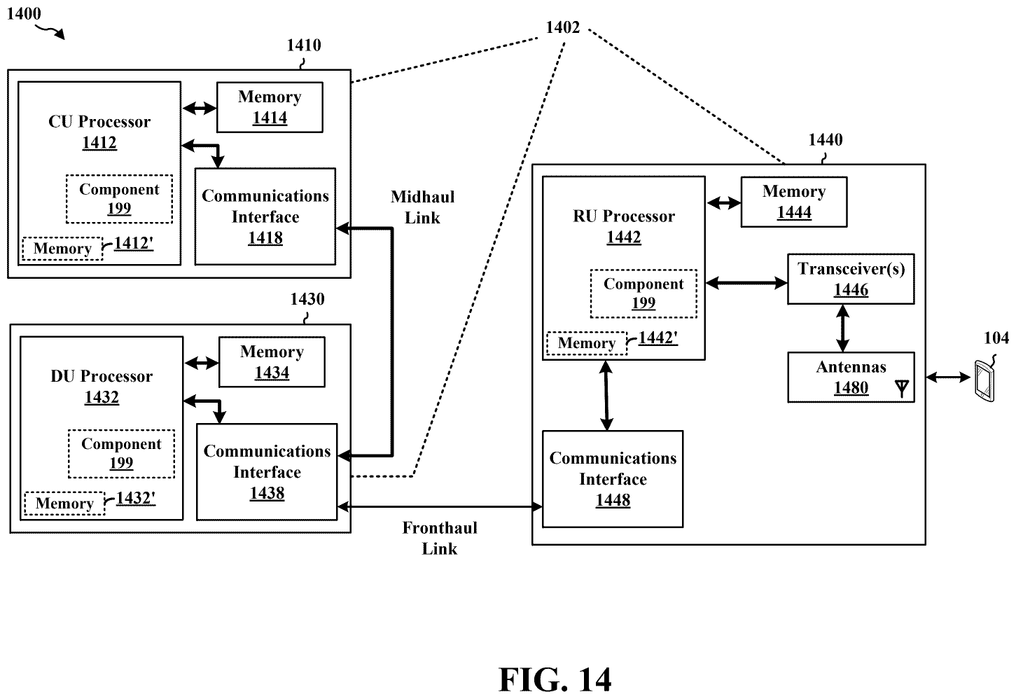

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor (or processing circuitry) 1412. The CU processor(s) (or processing circuitry) 1412 may include on-chip memory (or memory circuitry) 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor (or processing circuitry) 1432. The DU processor(s) (or processing circuitry) 1432 may include on-chip memory (or memory circuitry) 1432′. In some aspects, the DU 1430 may further include additional memory modules 1434 and a communications interface 1438. The DU 1430 communicates with the RU 1440 through a fronthaul link. The RU 1440 may include at least one RU processor (or processing circuitry) 1442. The RU processor(s) (or processing circuitry) 1442 may include on-chip memory (or memory circuitry) 1442′. In some aspects, the RU 1440 may further include additional memory modules 1444, one or more transceivers 1446, antennas 1480, and a communications interface 1448. The RU 1440 communicates with the UE 104. The on-chip memory (or memory circuitry) 1412′, 1432′, 1442′ and the additional memory modules 1414, 1434, 1444 may each be considered a computer-readable medium/memory (or memory circuitry). Each computer-readable medium/memory (or memory circuitry) may be non-transitory. Each of the processors (or processing circuitry) 1412, 1432, 1442 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, a wideband capability indicator that indicates a capability for performing multiple FFT operations on multiple narrowband segments of a wideband signal; and communicate the wideband signal, where the wideband signal has a continuous wideband bandwidth, the multiple narrowband segments each have different frequency shifts, and the wideband signal is associated with the multiple FFT operations. The component 199 may be further configured to perform any of the aspects described in connection with the flowcharts in FIG. 11 and FIG. 12, and/or performed by the base station 804 in FIG. 8. The component 199 may be within one or more processors (or processing circuitry) of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for receiving, from a UE, a wideband capability indicator that indicates a capability for performing multiple FFT operations on multiple narrowband segments of a wideband signal, and means for communicating the wideband signal, where the wideband signal has a continuous wideband bandwidth, the multiple narrowband segments each have different frequency shifts, and the wideband signal is associated with the multiple FFT operations. The network entity 1402 may further include means for performing any of the aspects described in connection with the flowcharts in FIG. 11 and FIG. 12, and/or aspects performed by the base station 804 in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining a first wideband signal having a continuous wideband bandwidth; separating the first wideband signal into multiple narrowband segments, where the multiple narrowband segments each have a narrowband bandwidth less than the continuous wideband bandwidth and different frequency shifts; performing multiple FFT operations on the multiple narrowband segments to obtain a set of processed segments respectively corresponding to the multiple narrowband segments; and aggregating the set of processed segments to obtain a second wideband signal. The methods allow the UE to divide a wideband signal into multiple narrowband segments and subsequently perform multiple FFT operations on these narrowband segments, as opposed to conducting a single FFT operation on the entire wideband signal. Hence, the methods allow for more efficient processing of wideband signals to accommodate a variety of use cases. In some examples, the methods incorporate a phase alignment and concatenation function to ensure phase continuity across the wideband bandwidth and allow the removal of guard bands within the wideband bandwidth. Hence, the methods enhance the resource efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes obtaining a first wideband signal having a continuous wideband bandwidth; separating the first wideband signal into multiple narrowband segments, wherein the multiple narrowband segments each have a narrowband bandwidth less than the continuous wideband bandwidth and different frequency shifts; performing multiple Faster Fourier Transform (FFT) operations on the multiple narrowband segments to obtain a set of processed segments respectively corresponding to the multiple narrowband segments; and aggregating the set of processed segments to obtain a second wideband signal.

Aspect 2 is the method of aspect 1, wherein there is no guard band located between the continuous wideband bandwidth of the first wideband signal.

Aspect 3 is the method of aspect 1, wherein the continuous wideband bandwidth is greater than or equal to 400 MHz, and each of the multiple FFT operations has a first input size that is less than or equal to 4096.

Aspect 4 is the method of any of aspects 1 to 3, where the method further includes transmitting, to a network entity, a wideband capability indicator that indicates a capability for performing multiple FFT operations on the multiple narrowband segments to obtain the set of processed segments.

Aspect 5 is the method of aspect 4, wherein the capability comprises one or more of: a maximum continuous wideband bandwidth supported in downlink (DL) reception, uplink (UL) transmission, or a combination of the DL reception and the UL transmission, a maximum continuous narrowband bandwidth supported for the multiple narrowband segments supported for each of the multiple FFT operations in the DL reception, the UL transmission, or the combination of the DL reception and the UL transmission, or a maximum number of the multiple FFT operations supported in the DL reception, the UL transmission, or the combination of the DL reception and the UL transmission.

Aspect 6 is the method of aspect 4, wherein the wideband capability indicator further comprises: a phase alignment indicator that indicates a support or a lack of the support for performing a phase alignment and concatenation operation after the multiple FFT operations, wherein the phase alignment and concatenation operation comprises an alignment and concatenation of the multiple narrowband segments to obtain the second wideband signal, wherein the second wideband signal has a continuous phase across the continuous wideband bandwidth.

Aspect 7 is the method of aspect 6, where the method further includes receiving, from the network entity, a size configuration for a physical resource block (PRB) group (PRG) size, wherein a PRG boundary of the PRG is aligned with a boundary of a maximum continuous narrowband bandwidth of the multiple narrowband segments.

Aspect 8 is the method of aspect 6, where the method further includes receiving, from the network entity, a size configuration for a physical resource block (PRB) group (PRG) size and a narrowband bandwidth configuration for a continuous narrowband bandwidth of each of the multiple narrowband segments, wherein a PRG boundary of the PRG is aligned with a boundary of the continuous narrowband bandwidth.

Aspect 9 is the method of aspect 6, where the method further includes receiving, from the network entity, a sub-band configuration for a sub-band size for a channel state information-reference signal (CSI-RS), wherein a sub-band boundary of a sub-band of the CSI-RS is aligned with a boundary of a maximum continuous narrowband bandwidth of the multiple narrowband segments.

Aspect 10 is the method of aspect 6, where the method further includes receiving, from the network entity, a sub-band configuration for a sub-band size for a channel state information-reference signal (CSI-RS) and a narrowband bandwidth configuration for a continuous narrowband bandwidth of each of the multiple narrowband segments, wherein a sub-band boundary of a sub-band of the CSI-RS is aligned with a boundary of the continuous narrowband bandwidth.

Aspect 11 is the method of aspect 6, wherein the phase alignment indicator indicates the support for performing the phase alignment and concatenation operation, and the method further includes receiving, from the network entity, a phase continuity configuration, wherein the phase continuity configuration comprises one or more of: a DL phase continuity indicator indicating a first phase continuity for the first wideband signal, or an UL phase continuity indicator indicating a phase continuity condition for the second wideband signal.

Aspect 12 is the method of aspect 11, wherein the DL phase continuity indicator indicates the first phase continuity across the multiple narrowband segments of the first wideband signal.

Aspect 13 is the method of aspect 11, wherein the UL phase continuity indicator indicates the phase continuity condition across multiple output narrowband segments of the second wideband signal.

Aspect 14 is the method of aspect 11, wherein receiving the phase continuity configuration includes receiving the phase continuity configuration via one of: radio resource control (RRC) signaling, a medium access control (MAC)-control element (MAC-CE), or downlink control information (DCI).

Aspect 15 is the method of aspect 11, where the method further includes transmitting, to the network entity, an indication to disable physical downlink control channel (PDCCH) blind detection, wherein the first wideband signal does not include a PDCCH transmission.

Aspect 16 is the method of any of aspects 1 to 15, where the method further includes transmitting, to a network entity, an FFT capability indicator indicating one or more first configuration sets associated with minimum time durations for the multiple FFT operations; and receiving, from the network entity based on the FFT capability indicator, one or more second configuration sets associated with the number of time slots for the multiple FFT operations, wherein the one or more second configuration sets are based on the one or more first configuration sets, and performing the multiple FFT operations includes performing, based on the one or more first configuration sets and the one or more second configuration sets, the multiple FFT operations.

Aspect 17 is the method of aspect 16, wherein the multiple FFT operations and a single FFT operation for a narrowband signal use a same first configuration set in the one or more first configuration sets and a same second configuration set in the one or more second configuration sets.

Aspect 18 is the method of aspect 16, wherein a first configuration set in the one or more first configuration sets for the multiple FFT operations is different from another first configuration set in the one or more first configuration sets for a single FFT operation for a narrowband signal, a second configuration set in the one or more second configuration sets for the multiple FFT operations is different from another second configuration set in the one or more second configuration sets for the single FFT operation for the narrowband signal, and a first number of FFT operations of the multiple FFT operations and a second number of FFT operations of the multiple FFT operations use a same first configuration set in the one or more first configuration sets and a same second configuration set in the one or more first configuration sets.

Aspect 19 is the method of aspect 16, wherein a first configuration set in the one or more first configuration sets for a first number of FFT operations of the multiple FFT operations is different from another first configuration set in the one or more first configuration sets for a second number of FFT operations of the multiple FFT operations, and a second configuration set in the one or more second configuration sets for the first number of FFT operations is different from another second configuration set in the one or more second configuration sets for the second number of FFT operations.

Aspect 20 is the method of aspect 16, wherein a first configuration set in the one or more first configuration sets for the multiple FFT operations with a phase alignment and concatenation operation is different from another first configuration set in the one or more first configuration sets for the multiple FFT operations without the phase alignment and concatenation operation, and a second configuration set in the one or more second configuration sets for the multiple FFT operations with the phase alignment and concatenation operation is different from another second configuration set in the one or more second configuration sets for the multiple FFT operations without the phase alignment and concatenation operation.

Aspect 21 is an apparatus for wireless communication at a UE, comprising: a processing system that includes processor circuitry and memory circuitry that stores code and is coupled with the processor circuitry, the processing system configured to cause the UE to perform the method of one or more of aspects 1-20.

Aspect 22 is an apparatus for wireless communication at a UE, comprising: at least one memory; and at least one processor coupled to the at least one memory and, where the at least one processor, individually or in any combination, is configured to perform the method of any of aspects 1-20.

Aspect 23 is the apparatus for wireless communication at a UE, comprising means for performing each step in the method of any of aspects 1-20.

Aspect 24 is an apparatus of any of aspects 21-23, further comprising a transceiver configured to receive or to transmit in association with the method of any of aspects 1-20.

Aspect 25 is a computer-readable medium (e.g., a non-transitory computer-readable medium) storing computer executable code at a UE, the code when executed by at least one processor causes the at least one processor to, individually or in any combination, perform the method of any of aspects 1-20.

Aspect 26 is a method of wireless communication at a network entity. The method includes receiving, from a user equipment (UE), a wideband capability indicator that indicates a capability for performing multiple Faster Fourier Transform (FFT) operations on multiple narrowband segments of a wideband signal; and communicating the wideband signal, wherein the wideband signal has a continuous wideband bandwidth, wherein the multiple narrowband segments each have different frequency shifts, and the wideband signal is associated with the multiple FFT operations.

Aspect 27 is the method of aspect 26, wherein there is no guard band located between the continuous wideband bandwidth of the wideband signal.

Aspect 28 is the method of aspect 26, wherein the continuous wideband bandwidth is greater than or equal to 400 MHz, and each of the multiple FFT operations has a first input size that is less than or equal to 4096.

Aspect 29 is the method of any of aspects 26 to 28, wherein the capability comprises one or more of: a maximum continuous wideband bandwidth supported in downlink (DL) reception, uplink (UL) transmission, or a combination of the DL reception and the UL transmission, a maximum continuous narrowband bandwidth supported for the multiple narrowband segments supported for each of the multiple FFT operations in the DL reception, the UL transmission, or the combination of the DL reception and the UL transmission, or a maximum number of the multiple FFT operations supported in the DL reception, the UL transmission, or the combination of the DL reception and the UL transmission.

Aspect 30 is the method of any of aspects 26 to 29, wherein the wideband capability indicator further comprises: a phase alignment indicator that indicates a support or a lack of the support for performing a phase alignment and concatenation operation after the multiple FFT operations, wherein the phase alignment and concatenation operation comprises an alignment and concatenation of the multiple narrowband segments.

Aspect 31 is the method of aspect 30, where the method further includes transmitting, for the UE, a size configuration for a physical resource block (PRB) group (PRG) size, wherein a PRG boundary of the PRG is aligned with a boundary of a maximum continuous narrowband bandwidth of the multiple narrowband segments, or transmitting, for the UE, the size configuration for the physical resource block (PRB) group (PRG) size and a narrowband bandwidth configuration for a continuous narrowband bandwidth of each of the multiple narrowband segments, wherein a PRG boundary of the PRG is aligned with a boundary of the continuous narrowband bandwidth.

Aspect 32 is the method of aspect 30, where the method further includes transmitting, for the UE, a sub-band configuration for a sub-band size for a channel state information-reference signal (CSI-RS), wherein a sub-band boundary of a sub-band of the CSI-RS is aligned with a boundary of a maximum continuous narrowband bandwidth of the multiple narrowband segments, or transmitting, for the UE, the sub-band configuration for the sub-band size for a channel state information-reference signal (CSI-RS) and a narrowband bandwidth configuration for a continuous narrowband bandwidth of each of the multiple narrowband segments, wherein a sub-band boundary of a sub-band of the CSI-RS is aligned with a boundary of the continuous narrowband bandwidth.

Aspect 33 is the method of aspect 30, wherein the phase alignment indicator indicates the support for the phase alignment and concatenation operation, and the method further includes transmitting, for the UE, a phase continuity configuration, wherein the phase continuity configuration comprises one or more of: a DL phase continuity indicator indicating a first phase continuity for the wideband signal, or an UL phase continuity indicator indicating a phase continuity condition for the wideband signal.

Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 26-33.

Aspect 35 is an apparatus for wireless communication at a network entity, comprising: at least one memory; and at least one processor coupled to the at least one memory and, where the at least one processor, individually or in any combination, is configured to perform the method of any of aspects 26-33.

Aspect 36 is the apparatus for wireless communication at a network entity, comprising means for performing each step in the method of any of aspects 26-33.

Aspect 37 is an apparatus of any of aspects 34-36, further comprising a transceiver configured to receive or to transmit in association with the method of any of aspects 26-33.

Aspect 38 is a computer-readable medium (e.g., a non-transitory computer-readable medium) storing computer executable code at a network entity, the code when executed by at least one processor causes the at least one processor to, individually or in any combination, perform the method of any of aspects 26-33.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain a first wideband signal having a continuous wideband bandwidth;
separate the first wideband signal into multiple narrowband segments, wherein the multiple narrowband segments each have a narrowband bandwidth less than the continuous wideband bandwidth and different frequency shifts;
perform multiple Faster Fourier Transform (FFT) operations on the multiple narrowband segments to obtain a set of processed segments respectively corresponding to the multiple narrowband segments; and
aggregate the set of processed segments to obtain a second wideband signal.

2. The apparatus of claim 1, further comprising a transceiver coupled to the at least one processor, wherein to obtain the first wideband signal, the at least one processor, individually or in any combination, is configured to obtain the first wideband signal via the transceiver, and wherein there is no guard band located between the continuous wideband bandwidth of the first wideband signal.

3. The apparatus of claim 1, wherein the continuous wideband bandwidth is greater than or equal to 400 MHz, and each of the multiple FFT operations has a first input size that is less than or equal to 4096.

4. The apparatus of claim 1, wherein the at least one processor, individually or in any combination, is further configured to:
transmit, to a network entity, a wideband capability indicator that indicates a capability for performing the multiple FFT operations on the multiple narrowband segments to obtain the set of processed segments.

5. The apparatus of claim 4, wherein the capability comprises one or more of:
a maximum continuous wideband bandwidth supported in downlink (DL) reception, uplink (UL) transmission, or a combination of the DL reception and the UL transmission,
a maximum continuous narrowband bandwidth supported for the multiple narrowband segments supported for each of the multiple FFT operations in the DL reception, the UL transmission, or the combination of the DL reception and the UL transmission, or
a maximum number of the multiple FFT operations supported in the DL reception, the UL transmission, or the combination of the DL reception and the UL transmission.

6. The apparatus of claim 4, wherein the wideband capability indicator further comprises:
a phase alignment indicator that indicates a support or a lack of the support for performing a phase alignment and concatenation operation after the multiple FFT operations, wherein the phase alignment and concatenation operation comprises an alignment and concatenation of the multiple narrowband segments to obtain the second wideband signal, and the second wideband signal has a continuous phase across the continuous wideband bandwidth.

7. The apparatus of claim 6, wherein the at least one processor, individually or in any combination, is further configured to:
receive, from the network entity, a size configuration for a physical resource block (PRB) group (PRG) size, wherein a PRG boundary of the PRG is aligned with a boundary of a maximum continuous narrowband bandwidth of the multiple narrowband segments.

8. The apparatus of claim 6, wherein the at least one processor, individually or in any combination, is further configured to:
receive, from the network entity, a size configuration for a physical resource block (PRB) group (PRG) size and a narrowband bandwidth configuration for a continuous narrowband bandwidth of each of the multiple narrowband segments, wherein a PRG boundary of the PRG is aligned with a boundary of the continuous narrowband bandwidth.

9. The apparatus of claim 6, wherein the at least one processor, individually or in any combination, is further configured to:
receive, from the network entity, a sub-band configuration for a sub-band size for a channel state information-reference signal (CSI-RS), wherein a sub-band boundary of a sub-band of the CSI-RS is aligned with a boundary of a maximum continuous narrowband bandwidth of the multiple narrowband segments.

10. The apparatus of claim 6, wherein the at least one processor, individually or in any combination, is further configured to:
receive, from the network entity, a sub-band configuration for a sub-band size for a channel state information-reference signal (CSI-RS) and a narrowband bandwidth configuration for a continuous narrowband bandwidth of each of the multiple narrowband segments, wherein a sub-band boundary of a sub-band of the CSI-RS is aligned with a boundary of the continuous narrowband bandwidth.

11. The apparatus of claim 6, wherein the phase alignment indicator indicates the support for performing the phase alignment and concatenation operation, and wherein the at least one processor, individually or in any combination, is further configured to:
receive, from the network entity, a phase continuity configuration, wherein the phase continuity configuration comprises one or more of:
a DL phase continuity indicator indicating a first phase continuity for the first wideband signal, or
an UL phase continuity indicator indicating a phase continuity condition for the second wideband signal.

12. The apparatus of claim 11, wherein the DL phase continuity indicator indicates the first phase continuity across the multiple narrowband segments of the first wideband signal.

13. The apparatus of claim 11, wherein the UL phase continuity indicator indicates the phase continuity condition across multiple output narrowband segments of the second wideband signal.

14. The apparatus of claim 11, wherein to receive the phase continuity configuration, the at least one processor, individually or in any combination, is configured to:
receive the phase continuity configuration via one of:
radio resource control (RRC) signaling,
a medium access control (MAC)-control element (MAC-CE), or
downlink control information (DCI).

15. The apparatus of claim 11, wherein the at least one processor, individually or in any combination, is further configured to:
transmit, to the network entity, an indication to disable physical downlink control channel (PDCCH) blind detection, wherein the first wideband signal does not include a PDCCH transmission.

16. The apparatus of claim 1, wherein the at least one processor, individually or in any combination, is further configured to:
transmit, to a network entity, an FFT capability indicator indicating one or more first configuration sets associated with minimum time durations for the multiple FFT operations; and
receive, from the network entity based on the FFT capability indicator, one or more second configuration sets associated with a number of time slots for the multiple FFT operations, wherein the one or more second configuration sets are based on the one or more first configuration sets, and wherein to perform the multiple FFT operations, the at least one processor, individually or in any combination, is configured to:
perform, based on the one or more first configuration sets and the one or more second configuration sets, the multiple FFT operations.

17. The apparatus of claim 16, wherein the multiple FFT operations and a single FFT operation for a narrowband signal use a same first configuration set in the one or more first configuration sets and a same second configuration set in the one or more second configuration sets.

18. The apparatus of claim 16, wherein
a first configuration set in the one or more first configuration sets for the multiple FFT operations is different from another first configuration set in the one or more first configuration sets for a single FFT operation for a narrowband signal,
a second configuration set in the one or more second configuration sets for the multiple FFT operations is different from another second configuration set in the one or more second configuration sets for the single FFT operation for the narrowband signal, and
a first number of FFT operations of the multiple FFT operations and a second number of FFT operations of the multiple FFT operations use a same first configuration set in the one or more first configuration sets and a same second configuration set in the one or more first configuration sets.

19. The apparatus of claim 16, wherein
a first configuration set in the one or more first configuration sets for a first number of FFT operations of the multiple FFT operations is different from another first configuration set in the one or more first configuration sets for a second number of FFT operations of the multiple FFT operations, and
a second configuration set in the one or more second configuration sets for the first number of FFT operations is different from another second configuration set in the one or more second configuration sets for the second number of FFT operations.

20. The apparatus of claim 16, wherein
a first configuration set in the one or more first configuration sets for the multiple FFT operations with a phase alignment and concatenation operation is different from another first configuration set in the one or more first configuration sets for the multiple FFT operations without the phase alignment and concatenation operation, and
a second configuration set in the one or more second configuration sets for the multiple FFT operations with the phase alignment and concatenation operation is different from another second configuration set in the one or more second configuration sets for the multiple FFT operations without the phase alignment and concatenation operation.

21. An apparatus for wireless communication at a network entity, comprising:
at least one memory; and
at least one processor coupled to the at least one memory and, based at least in part on information stored in the at least one memory, the at least one processor, individually or in any combination, is configured to:
receive, from a user equipment (UE), a wideband capability indicator that indicates a capability for performing multiple Faster Fourier Transform (FFT) operations on multiple narrowband segments of a wideband signal; and
communicate the wideband signal, wherein the wideband signal has a continuous wideband bandwidth, the multiple narrowband segments each have different frequency shifts, and the wideband signal is associated with the multiple FFT operations.

22. The apparatus of claim 21, further comprising a transceiver coupled to the at least one processor, wherein to receive the wideband capability indicator, the at least one processor, individually or in any combination, is configured to receive the wideband capability indicator via the transceiver, and wherein there is no guard band located between the continuous wideband bandwidth of the wideband signal.

23. The apparatus of claim 21, wherein the continuous wideband bandwidth is greater than or equal to 400 MHz, and each of the multiple FFT operations has a first input size that is less than or equal to 4096.

24. The apparatus of claim 21, wherein the capability comprises one or more of:
a maximum continuous wideband bandwidth supported in downlink (DL) reception, uplink (UL) transmission, or a combination of the DL reception and the UL transmission,
a maximum continuous narrowband bandwidth supported for the multiple narrowband segments supported for each of the multiple FFT operations in the DL reception, the UL transmission, or the combination of the DL reception and the UL transmission, or
a maximum number of the multiple FFT operations supported in the DL reception, the UL transmission, or the combination of the DL reception and the UL transmission.

25. The apparatus of claim 21, wherein the wideband capability indicator further comprises:
a phase alignment indicator that indicates a support or a lack of the support for performing a phase alignment and concatenation operation after the multiple FFT operations, wherein the phase alignment and concatenation operation comprises an alignment and concatenation of the multiple narrowband segments.

26. The apparatus of claim 25, wherein the at least one processor, individually or in any combination, is further configured to:
transmit, for the UE, a size configuration for a physical resource block (PRB) group (PRG) size, wherein a PRG boundary of the PRG is aligned with a boundary of a maximum continuous narrowband bandwidth of the multiple narrowband segments, or
transmit, for the UE, the size configuration for the physical resource block (PRB) group (PRG) size and a narrowband bandwidth configuration for a continuous narrowband bandwidth of each of the multiple narrowband segments, wherein the PRG boundary of the PRG is aligned with the boundary of the continuous narrowband bandwidth.

27. The apparatus of claim 25, wherein the at least one processor, individually or in any combination, is further configured to:
transmit, for the UE, a sub-band configuration for a sub-band size for a channel state information-reference signal (CSI-RS), wherein a sub-band boundary of a sub-band of the CSI-RS is aligned with a boundary of a maximum continuous narrowband bandwidth of the multiple narrowband segments, or
transmit, for the UE, the sub-band configuration for the sub-band size for the CSI-RS and a narrowband bandwidth configuration for a continuous narrowband bandwidth of each of the multiple narrowband segments, wherein the sub-band boundary of the sub-band of the CSI-RS is aligned with the boundary of the continuous narrowband bandwidth.

28. The apparatus of claim 25, wherein the phase alignment indicator indicates the support for the phase alignment and concatenation operation, and wherein the at least one processor, individually or in any combination, is further configured to:
transmit, for the UE, a phase continuity configuration, wherein the phase continuity configuration comprises one or more of:
a DL phase continuity indicator indicating a first phase continuity for the wideband signal, or
an UL phase continuity indicator indicating a phase continuity condition for the wideband signal.

29. A method of wireless communication at a user equipment (UE), comprising:
obtaining a first wideband signal having a continuous wideband bandwidth;
separating the first wideband signal into multiple narrowband segments, wherein the multiple narrowband segments each have a narrowband bandwidth less than the continuous wideband bandwidth and different frequency shifts;
performing multiple Faster Fourier Transform (FFT) operations on the multiple narrowband segments to obtain a set of processed segments respectively corresponding to the multiple narrowband segments; and
aggregating the set of processed segments to obtain a second wideband signal.

30. A method of wireless communication at a network entity, comprising:
receiving, from a user equipment (UE), a wideband capability indicator that indicates a capability for performing multiple Faster Fourier Transform (FFT) operations on multiple narrowband segments of a wideband signal; and
communicating the wideband signal, wherein the wideband signal has a continuous wideband bandwidth, wherein the multiple narrowband segments each have different frequency shifts, and wherein the wideband signal is associated with the multiple FFT operations.
